(19) United States
(12) Patent Application Publication
(10) Pub. No.: US 2024/0289638 A1
(43) Pub. Date: Aug. 29, 2024

(54) SYSTEMS AND METHODS FOR IMPROVED SECURE AGGREGATION IN FEDERATED LEARNING

(71) Applicant: University of Southern California, Los Angeles, CA (US)

(72) Inventors: Amir Salman Avestimehr, Rancho Palos Verdes, CA (US); Qian Yu, Lawrence Township, IN (US); Chaoyang He, Irvine, CA (US); Jinhyun So, Los Angeles, CA (US); Chien-Sheng Yang, Alhambra, CA (US)

(21) Appl. No.: 18/682,656

(22) PCT Filed: Aug. 18, 2022
(86) PCT No.: PCT/US2022/040805

§ 371 Date: Feb. 9, 2024

Related U.S. Application Data
(60) Provisional application No. 63/235,015, filed on Aug. 19, 2021.

(51) Int. Cl. G06N 3/098

(52) U.S. Cl. CPC G06N 3/098

(57) ABSTRACT

Systems and methods to generate a model based on a subset of models generated at remote devices include a first device operatively coupled with a second device. The first device can generate, based on a model parameter and data restricted to the first device, a first model via machine learning, partition the first model into a plurality of local mask shares each including a distinct portion of the first model, encode one or more of the plurality of local mask shares into a corresponding first plurality of encoded shares, and generate an aggregation of encoded shares including a first encoded share having a first index among the first plurality of encoded shares and a second encoded share having the first index among a second plurality of encoded shares. The second encoded share includes a distinct portion of a second model generated by a second device via machine learning.

### CROSS-REFERENCE TO RELATED PATENT APPLICATIONS

This application is a National Stage Entry under 35 U.S.C. § 371 of International Application No. PCT/US2022/040805, filed Aug. 18, 2022, which claims the benefit of priority under 35 U.S.C. § 119 to U.S. Provisional Patent Application Ser. No. 63/235,015, entitled “SYSTEMS AND METHODS FOR IMPROVED SECURE AGGREGATION IN FEDERATED LEARNING,” filed Aug. 19, 2021, the contents of such applications being hereby incorporated by reference in their entireties and for all purposes as if completely and fully set forth herein.

### STATEMENT REGARDING FEDERALLY SPONSORED RESEARCH OR DEVELOPMENT

This invention was made with government support under Grant Number CCF-1763673, awarded by the National Science Foundation (NSF). The Government has certain rights in the invention.

### INTRODUCTION

The computational requirements for machine learning have become increasing demanding as both models and the diversity of training data have increased in complexity. Distributed learning techniques, where multiple devices contribute to a single aggregated machine learning model, have emerged as one solution to this problem. However, distributed machine learning requires multiple devices to share information with one another, introducing a risk that the privacy of device information can be compromised. For example, the privacy of the data used to compute each devices share of the aggregate model is at risk through a model inversion attack, in which an attacker can reconstruct the training data from model parameters received or intercepted from a device. This is particularly troublesome when a device is training a model using private or protected information.

### SUMMARY

The systems and methods of this technical solution solve these and other issues by improving upon federated learning techniques to protect the privacy of device models. In addition, the techniques described herein eliminate computationally costly mask-reconstruction operations utilized in other techniques, thereby effecting a significant increase in computational performance without sacrificing device privacy. For example, other techniques may provide a secure aggregation but suffer from an overhead of O(N²) or O(log N). In addition, other techniques often provide lower privacy and dropout guarantees compared to the techniques described herein. In addition, the systems and methods described herein improve over other techniques by not requiring a trusted third party and by requiring much less randomness generation and at much smaller storage cost for each participating device. In addition, the systems and methods described herein can be applied to any aggregation-based approaches (e.g., FedNova, FedProx, FedOpt, etc.), as well as personalized FL frameworks (e.g., pFedMe, Ditto, Per-FedAvg, etc.).

At least one aspect of the disclosure relates to a system to generate a model based on a subset of models generated at remote devices. The system can include a first device operatively coupled with a second device. The first device can include a processor and memory. The processor and memory can generate, based on a model parameter and data restricted to the first device, a first model via machine learning. The processor and memory can partition the first model into a plurality of local mask shares each including a distinct portion of the first model. The processor and memory can encode one or more of the plurality of local mask shares into a corresponding first plurality of encoded shares. The processor and memory can generate an aggregation of encoded shares including a first encoded share having a first index among the first plurality of encoded shares and a second encoded share having the first index among a second plurality of encoded shares. The second encoded share can include a distinct portion of a second model generated by a second device via machine learning.

In some implementations, the first device can transmit, to the second device and based on a device index of the second device, the first plurality of encoded shares.

In some implementations, the first device can receive, from the second device and based on a device index of the first device, the second plurality of encoded shares.

In some implementations, the first device can generate a plurality of random masks each corresponding to one or more of the distinct portions of the first model. In some implementations, the first device can partition, based on the plurality of random masks, the plurality of local mask shares.

In some implementations, the first device can be remote from the second device.

In some implementations, the first device can transmit, to a server operatively coupled with the first device, the aggregation of encoded masks. In some implementations, the first device can transmit, to the server, the first plurality of encoded shares.

In some implementations, the first device can cause, in response to the transmission to the server, the server to generate, in response to a determination that the second device satisfies a dropout condition and based on the first plurality of encoded shares and the first aggregation of encoded shares, an aggregate model corresponding to a machine learning model comprising the first model and the second model.

In some implementations, the first device can cause, in response to the transmission to the server, the server to determine that the second device satisfies the dropout condition by a determination that an absence of transmission, from the second device, of second plurality of encoded shares each including a distinct portion of the second model generated by the second device.

In some implementations, the first device can receive, from a server operatively coupled with the first device, an instruction to generate via machine learning the first model based on the model parameter and the data restricted to the first device.

At least one aspect of the disclosure relates to a method. The method can generate a model based on a subset of models generated at remote devices. The method can include generating, based on a model parameter and data restricted to a first device operatively coupled with a second device, a first model via machine learning. The method can include partitioning the first model into a plurality of local mask shares each including a distinct portion of the first model. The method can include encoding one or more of the plurality of local mask shares into a corresponding first plurality of encoded shares. The method can include generating an aggregation of encoded shares including a first encoded share having a first index among the first plurality of encoded shares and a second encoded share having the first index among a second plurality of encoded shares. The second encoded share can include a distinct portion of a second model generated by a second device via machine learning.

In some implementations, the method can include transmitting, to the second device and based on a device index of the second device, the first plurality of encoded shares.

In some implementations, the method can include receiving, from the second device and based on a device index of the first device, the second plurality of encoded shares.

In some implementations, the method can include generating a plurality of random masks each corresponding to one or more of the distinct portions of the first model. In some implementations, the method can include partitioning, based on the plurality of random masks, the plurality of local mask shares.

In some implementations, the first device can be remote from the second device.

In some implementations, the method can include transmitting, to a server operatively coupled with the first device, the aggregation of encoded masks; and transmitting, to the server, the first plurality of encoded shares.

In some implementations, the method can include causing, in response to the transmission to the server, the server to generate, in response to a determination that the second device satisfies a dropout condition and based on the first plurality of encoded shares and the first aggregation of encoded shares, an aggregate model corresponding to a machine learning model comprising the first model and the second model.

In some implementations, the method can include causing, in response to the transmission to the server, the server to determine that the second device satisfies the dropout condition by a determination that an absence of transmission, from the second device, of second plurality of encoded shares each including a distinct portion of the second model generated by the second device.

In some implementations, the method can include receiving, from a server operatively coupled with the first device, an instruction to generate via machine learning the first model based on the model parameter and the data restricted to the first device.

At least one implementation relates to a computer readable medium. The computer readable medium can include one or more instructions stored thereon. The instructions can be executable by a processor. The instructions can be executable by the processor to generate, by the processor and based on a model parameter and data restricted to the first device, a first model via machine learning. The instructions can be executable by the processor to partition, by the processor, the first model into a plurality of local mask shares each including a distinct portion of the first model. The instructions can be executable by the processor to encode, by the processor, one or more of the plurality of local mask shares into a corresponding first plurality of encoded shares. The instructions can be executable by the processor to generate, by the processor, an aggregation of encoded shares including a first encoded share having a first index among the first plurality of encoded shares and a second encoded share having the first index among a second plurality of encoded shares, the second encoded share including a distinct portion of a second model generated by a second device via machine learning.

The computer readable medium can include one or more instructions executable by the processor to transmit, to the second device and based on a device index of the second device, the first plurality of encoded shares.

At least one other aspect of the present disclosure is directed to a method of securely aggregating masked model parameters generated by client devices. The method can be performed, for example, by one or more processors coupled to memory. The method can include transmitting a set of initial model parameters to a plurality of client devices participating in a distributed machine learning technique. The method can include receiving, from each of a first subset of the plurality of client devices, a respective set of masked model parameters updated using a machine learning technique executed at each of the subset of the plurality of client devices. The method can include identifying a second subset of the plurality of client devices that satisfy a dropout condition. The method can include transmitting, to each client device of the first subset of the plurality of client devices, a request for a local mask share corresponding to each client device in the second subset of the plurality of client devices. The method can include receiving, from each client device of the first subset, a set of local mask shares each corresponding to a respective client device in the first subset of the plurality of client devices. The method can include generating an aggregate model based on the respective set of masked model parameters received from the first subset and each set of local mask shares of the first subset of the plurality of client devices.

At least one aspect of the present disclosure is directed to a method. The method can be performed, for example, by a client device comprising one or more processors coupled to memory. The method can include generating, based on an initial set of model parameters, a set of updated model parameters using training data associated with the client device. The method can include generating a set of masked model parameters based on a generated local mask and the set of updated model parameters. The method can include generating, based on the local mask, a plurality of mask shares that each correspond to a respective one of a plurality of client devices participating in a distributed machine learning technique with the client device. The method can include transmitting each mask share of the plurality of mask shares to a respective client device of the plurality of client devices. The method can include receiving a plurality of encoded masks from the plurality of client devices. The method can include transmitting the set of masked model parameters to a machine learning system.

In some implementations, the method can include receiving a request for a subset of the plurality of encoded masks corresponding to a subset of the plurality of client devices that satisfy a participation condition. In some implementations, the method can include transmitting the subset of the plurality of encoded masks to the machine learning system.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the technical solution can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts an example diagram of the improved secure aggregation techniques described herein, in the example of three devices, in accordance with one or more implementations;

FIGS. 2A, 2B, 2C, 2D, 2E, 2F, and 2G depict example system flow diagrams of the improved secure aggregation techniques described herein in the case of N devices, in accordance with one or more implementations;

FIG. 3A depicts an example flow diagram of a method for improved secure aggregation in federated learning, in accordance with one or more implementations;

FIG. 3B depicts an example flow diagram of a method for generating secure masks for a secure aggregation in federated learning, in accordance with one or more implementations;

FIG. 4 depicts example timing diagrams of the present techniques compared to SecAgg+ for a single iteration to train MobileNetV3 with CIFAR-100 dataset, in accordance with on one or more implementations. SecAgg is not included as it takes much longer than other two protocols;

FIGS. 5A and 5B depict graphs of example total running time of the present techniques versus the other secure aggregation protocols (SecAgg and SecAgg+) to train CNN on the FEMNIST dataset, as the number of devices increases, for various dropout rates, in accordance with one or more implementations;

FIGS. 6A and 6B depict graphs of example total running time of the present techniques versus the other secure aggregation protocols (SecAgg and SecAgg+) to train logistic regression on the FEMNIST, as the number of devices increases, for various dropout rate, in accordance with one or more implementations;

FIGS. 7A and 7B depict graphs of example total running time of the present techniques versus the other secure aggregation protocols (SecAgg and SecAgg+) to train MobileNetV3 on the CIFAR-100, as the number of devices increases, for various dropout rate, in accordance with one or more implementations;

FIGS. 8A and 8B depict graphs of example total running time of the present techniques versus the state-of-the-art protocols (SecAgg and SecAgg+) to train EfficientNet-B0 on the GLD23k, as the number of devices increases, for various dropout rate, in accordance with one or more implementations.

FIGS. 9A and 9B are block diagrams depicting embodiments of computing devices useful in connection with the methods and systems described herein.

FIG. 10 illustrates a method performable by one or more client device in accordance with present implementations.

FIG. 11 illustrates a method to generate a model based on a subset of models generated at remote devices in accordance with present implementations.

### DETAILED DESCRIPTION

For purposes of reading the description of the various embodiments below, the following descriptions of the sections of the specification and their respective contents may be helpful:

Section A describes embodiments of systems and methods for improved secure aggregation in federated learning;

Section B includes experimental data and proofs of theorems relating to features described in Section A; and

Section C describes a network environment and computing environment which may be useful for practicing embodiments described herein

### A. Systems and Methods for Improved Secure Aggregation in Federated Learning

Federated learning (FL) has emerged as a promising approach to enable distributed training over a large number of devices, while protecting the privacy of each device. The approach of FL is to keep devices' data on their devices and instead train local models at each device. The locally trained models would then be aggregated via a server to update a global model, which is then pushed back to devices. Due to model inversion attacks, a critical consideration in FL design is to also ensure that the server does not learn the locally trained model of each device during model aggregation. Furthermore, model aggregation should be robust to likely device dropouts (due to poor connectivity, low battery, unavailability, etc.) in FL systems.

Other secure aggregation protocols rely on two main principles: (1) pairwise random-seed agreement between devices in order to generate masks that hide devices' models while having an additive structure that allows their cancellation when added at the server, such as SecAgg and SecAgg+; and (2) secret sharing of the random-seeds, in order to enable the reconstruction and cancellation of masks belonging to dropped devices. However, such approaches are severely bottlenecks by the number of mask reconstructions at the server, which grows substantially as more devices are dropped. This causes a major computational bottleneck and greatly reduces the efficiency of federated learning. Other approaches aimed at reducing this computational bottleneck either significantly increase round or communication complexity, as in TurboAgg (thereby further reducing security and computational performance), or compromise the dropout and privacy guarantees, thereby reducing the efficiency of aggregate model reconstruction. Other approaches like FastSecAgg provide lower privacy and dropout guarantees compared with other implementations.

The systems and methods described herein provide a secure model aggregation in FL, by performing a one-shot aggregate-mask reconstruction of surviving devices rather than performing a pairwise random-seed reconstruction of dropped devices, as in SecAgg or SecAgg+. Using these techniques, the systems and methods described herein provide the optimal privacy and dropout-resiliency guarantees while substantially reducing the aggregation and run-time complexity. This provides a significant improvement to federated learning techniques. In addition, the systems and methods described herein are in improvement over other implementations because the techniques described herein do not require a trusted third party to prepare device dropout patterns.

Using the techniques described herein, each device protects its local model using a locally generated random mask. This mask is then encoded and shared to other device, in such a way that the aggregate-mask of any sufficiently large set of surviving (e.g., still connected to the server and performing training, etc.) devices can be directly reconstructed at the server. In contrast to other techniques, such as SecAgg or SecAgg+, in this approach the server only needs to reconstruct one mask in the recovery phase, independent of the number of dropped devices. The systems and methods described herein further provide a system-level optimizations to improve overall run-time by taking advantage of the fact that the generation of random masks is independent of the computation of the local model, hence each device can parallelize these two operations via a multi-thread processing, which is beneficial to all evaluated secure aggregation protocols in reducing the total running time.

The systems and methods described herein can be utilized to train any type of machine learning model, including logistic regression, convolutional neural network (CNN), MobileNetV3, and EfficientNet-B0, for image classification over datasets of different image sizes: low resolution images (FEMNIST, CIFAR-100), and high resolution images (Google Landmarks Dataset 23k), among others. The example results described herein show that the present techniques provide significant speedup for all considered FL training tasks in the running time over other approaches, and in some implementations achieves a performance gain of 12.7×. Compared to other approaches, the techniques described herein can even survive and speedup the training of large deep neural network models on high resolution image datasets.

The systems and methods described herein can be utilized with any type of federated learning technique. As described herein, federated learning is a distributed training framework for machine learning in mobile networks while preserving the privacy of device information and training data information. One goal of federated learning is to learn the parameter for the global model x with dimension d, using data held at mobile devices. This can be represented by minimizing a global objective function F: F(x)=Σᵢ₌₁^{N}pᵢ Fᵢ (x) where N is the total number of devices, Fᵢ is the local objective function of device i, and pᵢ≥0 is a weight parameter assigned to device i to specify the relative impact of each device such that Σᵢ₌₁^{N}pᵢ=1. For example, all devices can have equal-sized datasets, e.g.,

$${p}_{i} = \frac{1}{N}$$

for all i∈[N].

Training can be performed through an iterative process where mobile devices interact through the central server to update the global model. At each iteration, the server shares the current state of the global model, denoted by x(t), with the mobile devices. Each device i creates a local update, xᵢ(t). The local models of the N devices can be sent to the server and then aggregated by the server. Using the aggregated models, the server updates the global model x(t+1) for the next iteration. In FL, some devices may potentially drop from the learning procedure due to unreliable communication connections. The goal of the server is to obtain the sum of the remaining surviving devices' local models. This update equation is given by

$$x ( t + 1 ) = \frac{1}{\vert 𝒰 ( t ) \vert} {\sum }_{i ∈ 𝒰 ( t )} {x}_{i} ( t ) ,$$

where [symbol] (t) denotes the set of surviving devices at iteration t. Then, the server pushes the updated global model x(t+1) to the mobile devices.

As the local models carry extensive information about the local datasets stored at the devices, e.g., the private data from the local models can be reconstructed by using a model inversion attack. To address such privacy leakage from the local models, secure aggregation has been introduced. A secure aggregation protocol enables the computation of the aggregation operation while ensuring that the server learns no information about the local models xᵢ(t) beyond their aggregated model. In particular, our goal is to securely evaluate the aggregate of the local models y=Σ_{i∈U}xᵢ, where the iteration index t is omitted for simplicity. Since secure aggregation protocols build on cryptographic primitives that require all operations to be carried out over a finite field, it is assumed that the elements of xᵢ and y can be from a finite field F_{q} for some field size q. The performance of a secure aggregation protocol for FL is evaluated through the following two key guarantees.

The systems and methods described herein provide a privacy guarantee. A threat model is considered where the devices and the server are honest but curious. It is assumed that up to T devices can collude with each other as well as with the server to infer the local models of other devices. The secure aggregation protocol has to guarantee that nothing can be learned beyond the aggregate-model, even if up to T devices cooperate with each other. Privacy is considered in the information-theoretic sense. For every subset of devices [symbol] ⊆[N] of size at most T, there must be mutual information I({xᵢ}_{i∈[N]}; Y|Σ_{i∈U}xi, [symbol] )=0, where Y is the collection of information at the server, and [symbol] is the collection of information at the devices in [symbol] .

The systems and methods described herein provide a drop-out resiliency guarantee. In FL, devices may get dropped or delayed at any time during protocol execution due to various reasons, e.g., poor wireless channel conditions, low battery, etc. It is assumed that there can be at most D dropped devices during the execution of protocol, e.g., there can be at least N−D surviving devices after potential dropouts. The protocol has to guarantee that the server can correctly recover the aggregated models of the surviving devices, even if up to D devices drop.

The systems and methods described herein provide an efficient and scalable secure aggregation protocol that simultaneously achieves strong privacy and dropout-resiliency guarantees, scaling linearly with the number of devices N, e.g., simultaneously achieves privacy guarantee

$$T = \frac{N}{2}$$

and dropout-resiliency guarantee

$$D = \frac{N}{2} - 1 .$$

It is noted that SecAgg, and other secure aggregation protocols, requires the server to compute a PRG function on each of reconstructed seeds to recover the aggregated masks, which incurs the overhead of O(N²) and dominates the overall execution time of the protocol. SecAgg+ reduces the overhead of mask reconstructions from O(N²) to O(N logN) by replacing the complete communication graph of SecAgg with a sparse random graph of degree O(log N) to reduce both communication and computation loads. Reconstructing pairwise random masks in SecAgg and SecAgg+ poses major bottlenecks in scaling to a large number of devices. To overcome such computational bottleneck, the systems and methods described herein enable the server to recover the aggregate-mask of all surviving devices in one shot, while maintaining the same privacy and dropout-resiliency guarantees. Both SecAgg, SecAgg+, and other secure aggregation protocols, lack such one-shot mask generation of the techniques described herein, making the techniques described herein a significant improvement over other secure aggregation techniques in terms of privacy guarantees, dropout resiliency, and overall computational performance.

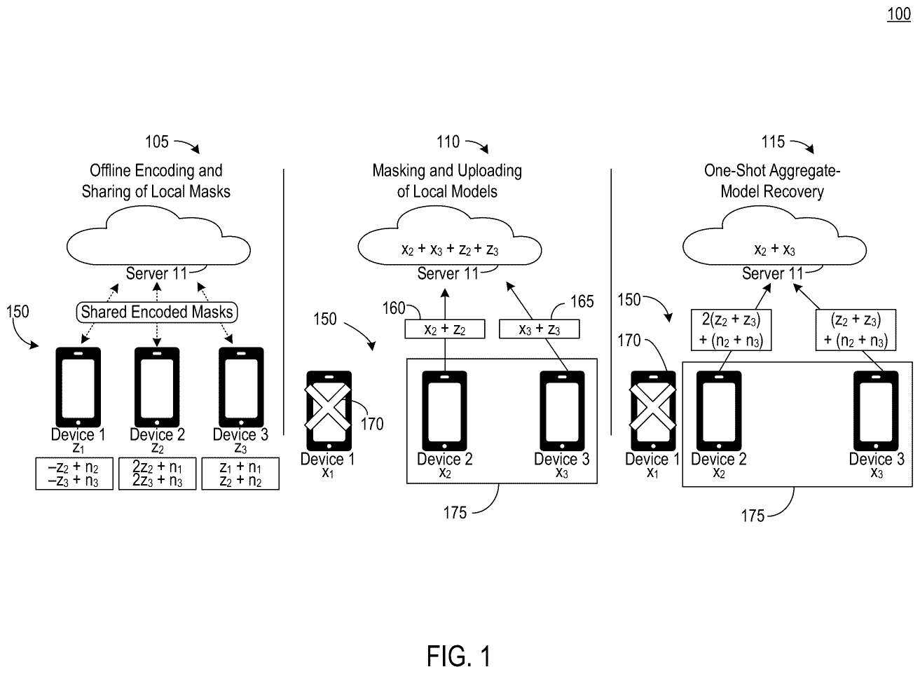

Referring now to FIG. 1, depicted is an example diagram 100 of the improved secure aggregation techniques described herein (LightSecAgg), in the example 3 devices, in accordance with one or more implementations. The diagram shown in FIG. 1 includes the phases 105, 110, and 115, which each correspond to a respective phase of the LightSecAgg secure aggregation protocol. Each of the phases 105, 110, and 115 show a server 11 (sometimes referred to herein as the “machine learning system”) in communication with devices 1, 2, and 3, referred to generally as devices 150. The server 11 can be in communication with each of the devices 1, 2, and 3, for example, via a communication network (not shown). Although only 3 devices are shown here, it should be understood that the system can include any number of N devices, e.g., devices 1, 2, . . . , N.

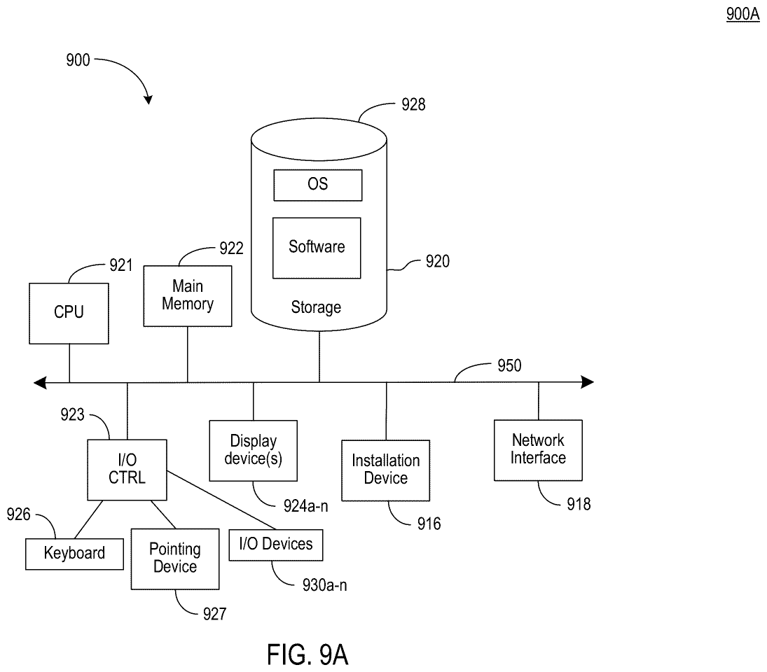

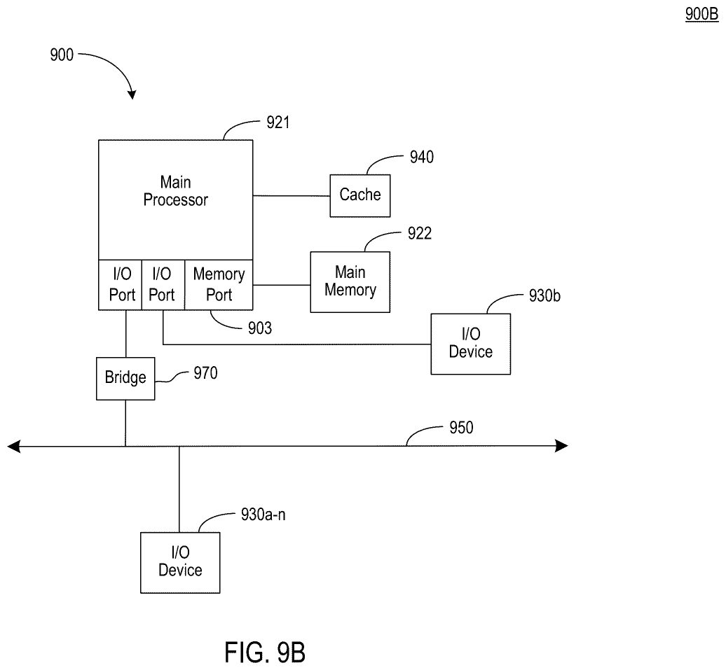

The server 11 can include at least one processor and a memory, e.g., a processing circuit. The memory can store processor-executable instructions that, when executed by processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The server 11 can include one or more computing devices or servers that can perform various functions as described herein. The server 11 can include any or all of the components and perform any or all of the functions of the computer system 900 described herein in conjunction with FIGS. 9A-9B in views 900A and 900B.

Each device 150 (e.g., device 1, device 2, . . . , device N) (sometimes referred to herein as “client device(s) 150”) can include at least one processor and a memory, e.g., a processing circuit. The memory can store processor-executable instructions that, when executed by processor, cause the processor to perform one or more of the operations described herein. The processor may include a microprocessor, an ASIC, an FPGA, etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions may include code from any suitable computer programming language. Each device 150 (e.g., device 1, device 2, . . . , device N) can include one or more computing devices or servers that can perform various functions as described herein. Each device 1, 2, ... , N can include any or all of the components and perform any or all of the functions of the computer system 900 described herein in conjunction with FIGS. 9A-9B.

The communication network via which the server 11 and the devices 1, 2, . . . , N communicate can include computer networks such as the Internet, local, wide, metro or other area networks, intranets, satellite networks, other computer networks such as voice or data mobile phone communication networks, and combinations thereof. The server 11 can communicate via the network, for instance with one or more of the devices 1, 2, . . . , N. The network may be any form of computer network that can relay information between the server 11, the one or more devices 1, 2, . . . , N, and one or more information sources, such as web servers or external databases, amongst others. In some implementations, the network may include the Internet and/or other types of data networks, such as a local area network (LAN), a wide area network (WAN), a cellular network, a satellite network, or other types of data networks. The network may also include any number of computing devices (e.g., computers, servers, routers, network switches, etc.) that can be configured to receive and/or transmit data within the network. The network may further include any number of hardwired and/or wireless connections. Any or all of the computing devices described herein (e.g., the server 11, the devices 1, 2, . . . , N, the computer system 900, etc.) may communicate wirelessly (e.g., via WiFi, cellular, radio, etc.) with a transceiver that is hardwired (e.g., via a fiber optic cable, a CAT5 cable, etc.) to other computing devices in the network. Any or all of the computing devices described herein (e.g., the server 11, the devices 1, 2, . . . , N, the computer system 900, etc.) may also communicate wirelessly with the computing devices of the network via a proxy device (e.g., a router, network switch, or gateway). In some implementations, the network can form a part of a cloud computing system.

As shown in phase 105 of the diagram 100, each device 150. One of the devices 150 may be referred to herein as device i∈{1,2,3}. Device i∈{1,2,3}, holds (e.g., stores in a memory, etc.) a local model xᵢ∈ [symbol] _{q}^{d}. Each device 150 first generates a single mask. Each mask of a device is encoded and shared to other devices. Each device's local model is protected by its generated mask. Suppose that device 1 drops during the execution of protocol. The server 11 directly recovers the aggregate-mask in one shot. In this example, the techniques described herein (sometimes referred to as “LightSecAgg,” the “LightSecAgg protocol,” or the “present techniques”) reduces the computational cost at the server 11 from 4d (e.g., of other protocols) to d. Before providing a general description of the techniques described herein, aspects of the protocol can be described through the 3-device example shown in FIG. 1 As shown in FIG. 1, LightSecAgg has the following three phases:

The first phase 105 of the present techniques includes offline encoding and sharing of local masks between client devices participating in the distributed machine learning technique. Device i∈{1,2,3} randomly picks zᵢ and nᵢ from [symbol] _{q}^{d}. Device i∈{1,2,3} creates the masked version of zᵢ by encoding zᵢ and nᵢ,

$${\tilde{z}}_{1 , 1} = - {z}_{1} + {n}_{1} , \qquad ( 4 )$$

$${\tilde{z}}_{1 , 2} = 2 {z}_{1} + {n}_{1} ,$$

$${\tilde{z}}_{1 , 3} = {z}_{1} + {n}_{1} ;$$

$${\tilde{z}}_{2 , 1} = - {z}_{2} + {n}_{2} , \qquad ( 5 )$$

$${\tilde{z}}_{2 , 2} = 2 {z}_{2} + {n}_{2} ,$$

$${\tilde{z}}_{2 , 3} = {z}_{2} + {n}_{2} ;$$

$${\tilde{z}}_{3 , 1} = - {z}_{3} + {n}_{3} , \qquad ( 6 )$$

$${\tilde{z}}_{3 , 2} = 2 {z}_{3} + {n}_{3} ,$$

$${\tilde{z}}_{3 , 3} = {z}_{3} + {n}_{3} ;$$

and device i sends \tilde{z}_{i,j} to each device j∈{1,2,3}. Device j∈{1,2,3} may refer to one of the devices 150 that is not device i∈{1,2,3}. Thus, device i receives \tilde{z}_{j,i} for j∈{1,2,3}. In this case, this procedure provides robustness against 1 dropped device, shown in FIG. 1 as dropped device 170, and privacy against 1 curious device. Non-dropped devices may be referred to as surviving devices 175. Each value of \tilde{z}_{i,j} or \tilde{z}_{j,i} can be referred to herein as a “local mask share.” As shown, each local mask share can be determined based by randomly selecting values zᵢ and nᵢ from the F-space [symbol] _{q}^{d}. In some implementations, this can include executing a random number generator that returns random values from [symbol] _{q}^{d}. In some implementations, the random number generator can be a pseudo-random number generator that utilizes a suitable pseudo-random number generation process.

The next phase 110 of the present techniques includes masking and uploading of local models. To make each individual model private, each surviving device 175 (e.g., device i∈{1,2,3}) masks its local model as follows:

$${\tilde{x}}_{1} = {x}_{1} + {z}_{1} , \qquad ( 7 )$$

$${\tilde{x}}_{2} = {x}_{2} + {z}_{2} ,$$

$${\tilde{x}}_{3} = {x}_{3} + {z}_{3} ,$$

and sends its masked model to the server 11, as shown by models 160 and 165 in FIG. 1. This stage can follow the execution of a machine learning process to update the set of parameters xᵢ. As described herein, the machine learning process can be any type of machine learning process, including a neural network process or logistic regression process, among others.

The third phase 115 of the present techniques includes one-shot aggregate-model recovery. Suppose that device 1 drops in the previous phase (i.e., device 1 is a dropped device 170). To recover the aggregate of models x₂+x₃, the server 11 only needs to know the aggregated masks z₂+z₃. To recover z₂+z₃, the surviving devices 175 (e.g., device 2 and device 3) send \tilde{z}_{2,2}+\tilde{z}_{3,2} and \tilde{z}_{2,3}+\tilde{z}_{3,3},

$${\tilde{z}}_{2 , 2} + {\tilde{z}}_{3 , 2} = 2 ( {z}_{2} + {z}_{3} ) + {n}_{2} + {n}_{3} , \qquad ( 8 )$$

$${\tilde{z}}_{2 , 3} + {\tilde{z}}_{3 , 3} = ( {z}_{2} + {z}_{3} ) + {n}_{2} + {n}_{3} ,$$

to the server 11, respectively. After receiving the messages from surviving devices 175 (e.g., device 2 and device 3), the server 11 can directly recover the aggregated masks via a one-shot computation as follows:

$${z}_{2} + {z}_{3} = {\tilde{z}}_{2 , 2} + {\tilde{z}}_{3 , 2} - ( {\tilde{z}}_{2 , 3} + {\tilde{z}}_{3 , 3} ) . \qquad ( 9 )$$

Then, the server 11 recovers the aggregate-model x₂+x₃ by subtracting z₂+z₃ from \tilde{x}₂+\tilde{x}₃. As opposed to other techniques, such as SecAgg, which has to reconstruct the dropped random seeds, the present techniques enable the server to reconstruct the desired aggregate of masks via a direct one-shot recovery. Compared with SecAgg, for example, present techniques reduce the server's computational cost from 4d to d in this simple example, which is a significant technical improvement. Although the foregoing has been described in the context of only three devices, it should be understood that the present techniques can be expanded to accommodate any number of client devices 150 participating in a distributed learning protocol, such as federated learning.

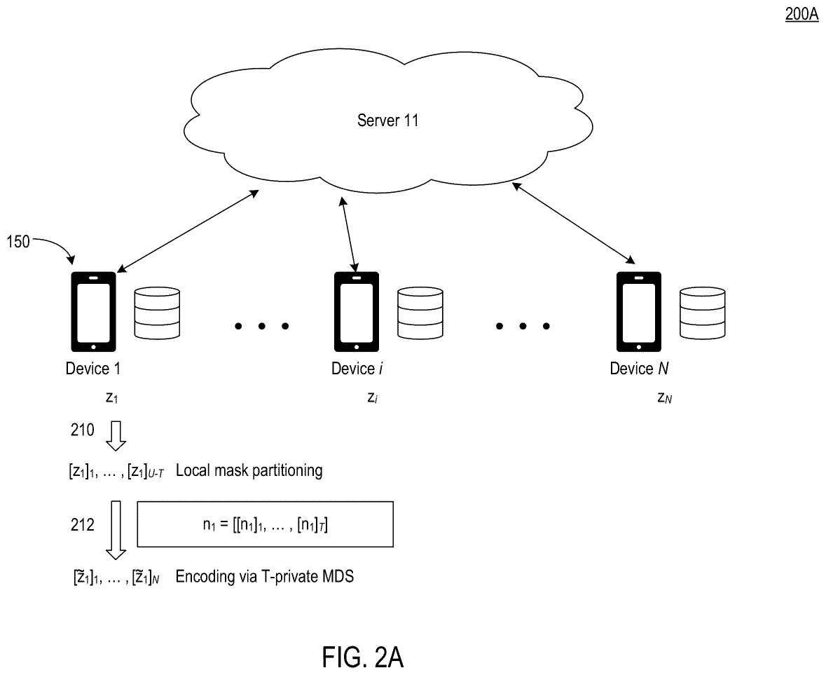

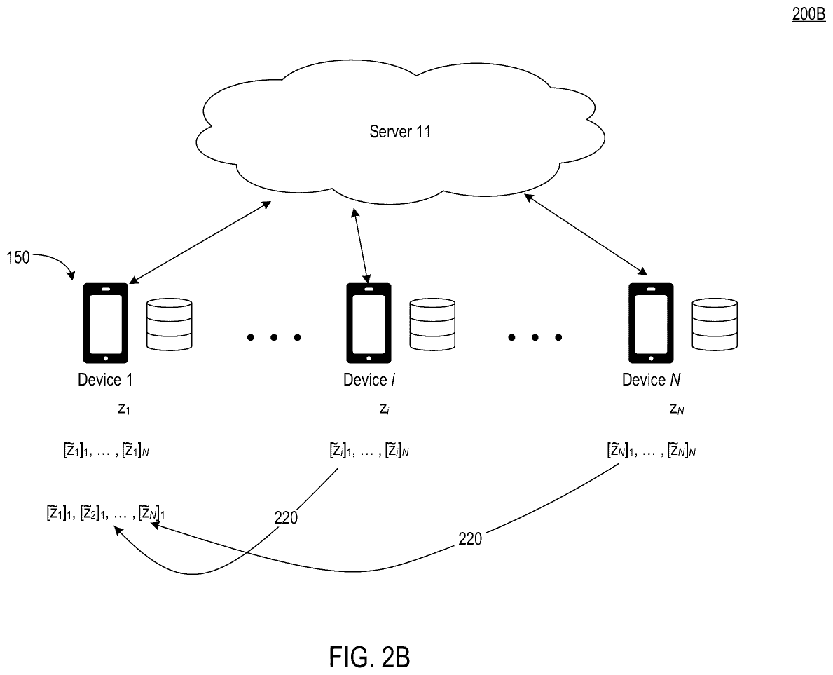

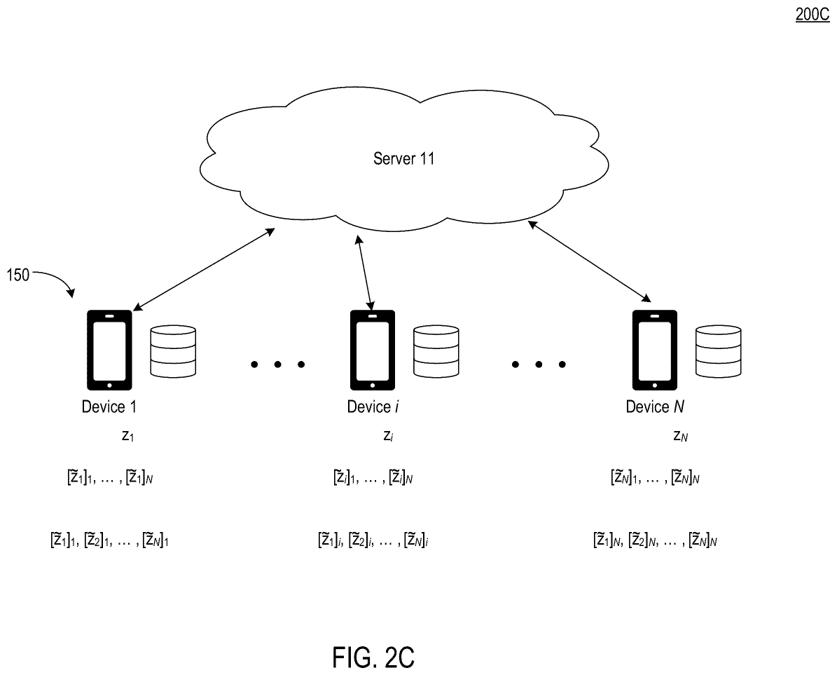

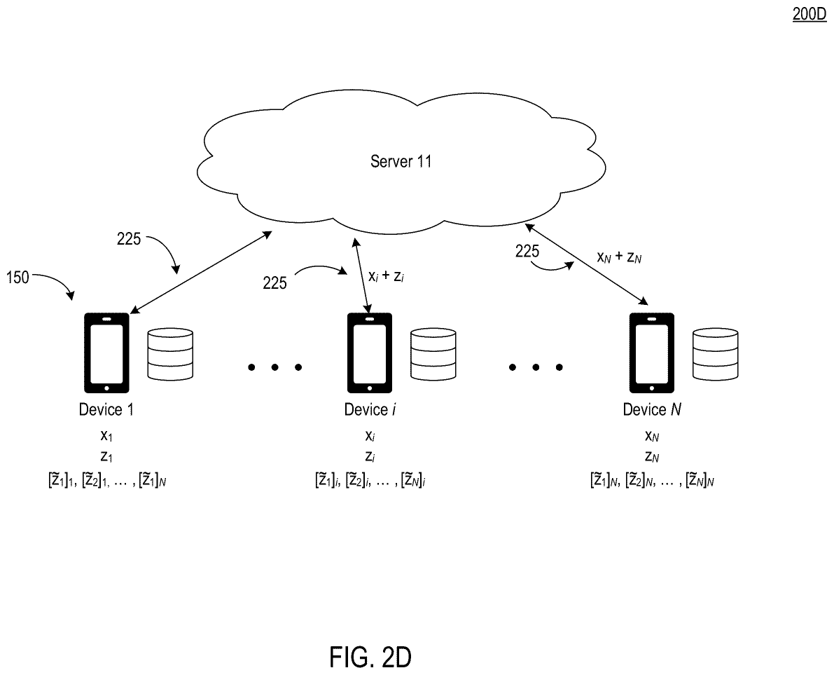

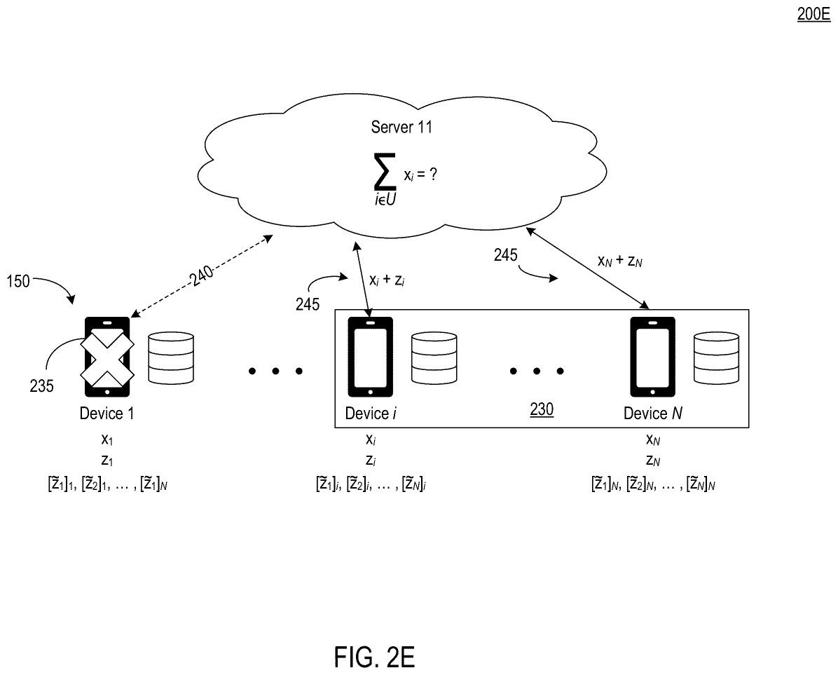

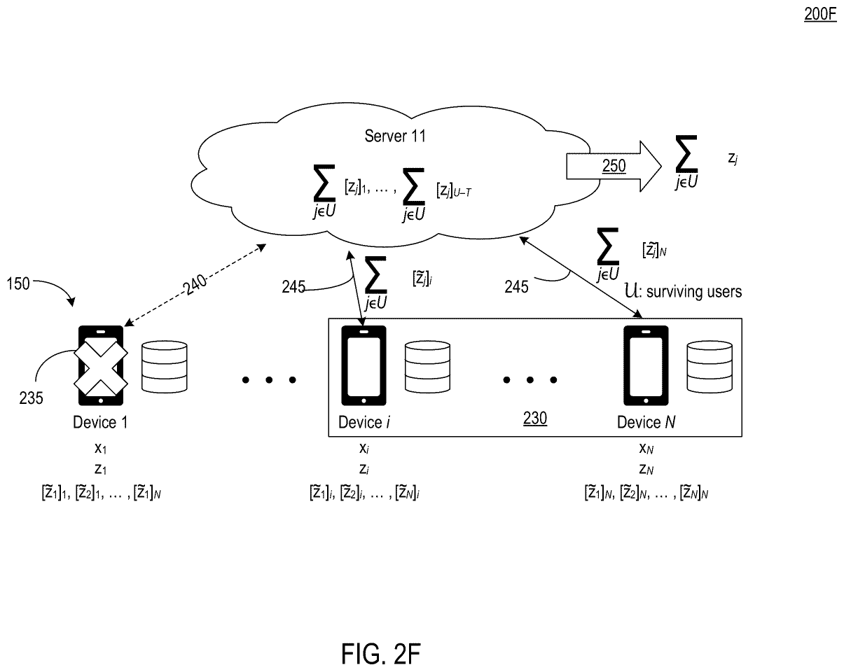

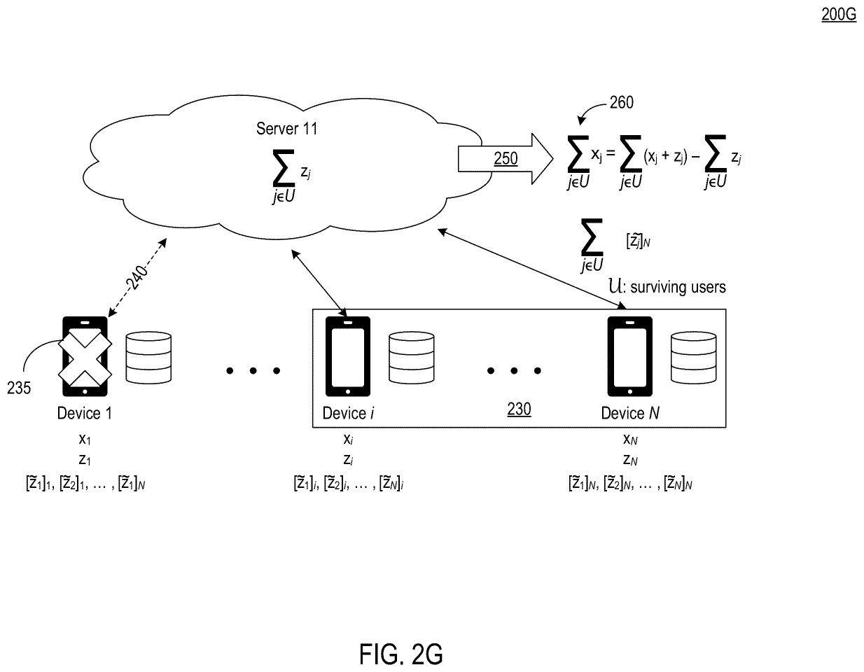

Referring now to FIGS. 2A, 2B, 2C, 2D, 2E, 2F, and 2G respectively depict example system flow states 200A, 200B, 200C, 200D, 200E, 200F and 200G (collectively, e.g., “200”) of the improved secure aggregation techniques described herein in the case of N devices, in accordance with one or more implementations. The systems and methods described herein can encode the local generated random masks in a way that the server can recover the aggregate of masks from the encoded masks via a one-shot computation with a cost that does not scale with N. The present techniques have at least three design parameters: (1) 0≤T≤N−1 representing the privacy guarantee; (2) 0≤D≤N−1 representing the dropout-resiliency guarantee; (3) 0≤U≤N−1 representing the targeted number of surviving devices. In particular, parameters T, D and U can be selected such that N−D≥U>T≥0.

The present techniques can include three phases. First, as shown in FIG. 2A, each device 150 (e.g., device 1, device i, . . . , device N) first partitions its local random mask to U−T pieces, as shown in process 210, and creates encoded masks by an encoding process 212 via a Maximum Distance Separable (MDS) code to provide robustness against D dropped devices 170 and privacy against T colluding devices 1, i, . . . , N. As shown in FIGS. 2B and 2C, each device 150 (e.g., device 1, device i, . . . , device N) sends one of encoded masks to one of other devices 150 (e.g., device 1, device i, ... , device N) for the purpose of one-shot recovery, as shown by process 220. Then, as shown in FIG. 2D, each device 150 (e.g., device 1, device i, . . . , device N) uploads its masked local model to the server 11, shown by processes 225. Then, as shown in FIG. 2E, the goal of the server 11 is to reconstruct the aggregated masks of the surviving devices i, . . . , N, shown as surviving devices 230, even where a device under a dropout condition (e.g., dropped device 235), can cannot transmit or complete transmission to the server 11, as indicated by line 240. In FIG. 2E, each surviving device 230 sends the aggregated encoded masks to the server 11, indicated by communication lines 245. In FIGS. 2F and 2G, after receiving U aggregated encoded masks from the surviving devices 230, indicated by communications lines 250, the server 11 recovers the aggregate-mask and the desired aggregate-model. The pseudo code of the LightSecAgg protocol (e.g., the present techniques) is provided in Section B. Each of these phases is described in detail herein below.

As described herein above, and as shown in FIGS. 2A, 2B, 2C, 2D, 2E, 2F, and 2G, one aspect of the present techniques includes offline encoding and of local masks. Device i∈[N] picks zᵢ uniformly at random from [symbol] _{q}^{d} and mask zᵢ is partitioned to U−T sub-masks

$${[ {z}_{i} ]}_{k} ∈ {𝔽}_{q}^{\frac{d}{U - T}} ,$$

$$k ∈ [ U - T ] .$$

With the randomly picked

$${[ {n}_{i} ]}_{k} ∈ {𝔽}_{q}^{\frac{d}{U - T}}$$

$$for$$

$$k ∈ \{ U - T + 1 , … , U \}$$

device i∈[N] encodes sub-masks [zᵢ]ₖ's as

$${[ {\tilde{z}}_{i} ]}_{j} = ( {[ {z}_{i} ]}_{1} , … , {[ {z}_{i} ]}_{U - T} , {[ {n}_{i} ]}_{U - T + 1} , … , {[ {n}_{i} ]}_{U} ) \cdot {W}_{j} , \qquad ( 10 )$$

where Wⱼ is j'th column of a T-private MDS matrix W∈ [symbol] _{q}^{U×N} of dimension U×N . In particular, an MDS matrix is T-private if the submatrix consists of its {U−T+1, . . . , U}−th rows is also MDS. A T-private MDS matrix guarantees I (\tilde{z}ᵢ; {[\tilde{z}ᵢ]ⱼ [symbol] )=0, for any i∈[N] and any [symbol] ⊆[N] of size T, if [nᵢ]ₖ's can be jointly uniformly random. T-private MDS matrices can be calculated for any U, N, and T. As described herein, the values U, N, D, and T can be predetermined, specified by an operator of the server, or received from another computing device via the communication network. Each device i∈[N] sends [\tilde{z}ᵢ]ⱼ to device j∈[N]\{i} In the end of offline encoding and sharing 220 of local masks, each device i∈[N] has [\tilde{z}ⱼ]ᵢ from j∈[N]. A T-private MDS guarantees privacy against any T colluding devices.

As described herein, another aspect of the present techniques includes masking and uploading of local models. To protect local models, each device i masks its local model as \tilde{x}ᵢ=xᵢ+zᵢ, and sends it to the server 11. Since some devices may drop in this phase, the server 11 identifies the set of surviving devices, denoted by [symbol] ₁⊆[N]. The server 11 intends to recover [symbol] xᵢ.

As described herein, another aspect of the present techniques includes one-shot aggregate-model recovery. After identifying the surviving devices in the previous phase, device j∈ [symbol] ₁, is informed to send its aggregated encoded sub-masks [symbol] [\tilde{z}ᵢ]ⱼ to the server 11 for the purpose of one-shot recovery. It is noted that each [symbol] [\tilde{z}ᵢ]ⱼ is an encoded version [symbol] [zᵢ]ₖ for 5∈[U−T] using the MDS matrix W (see more details in Section B). Thus, the server 11 is able to recover a set of any U messages from the participating devices, where this set is denoted by [symbol] ₂, | [symbol] ₂|=U. The server 11 obtains the aggregated masks [symbol] zᵢ by concatenating [symbol] [zᵢ]ₖ's 250. Lastly, the server 11 recovers the desired aggregate of models 260 for the set of participating devices [symbol] ₁ by subtracting [symbol] zᵢ from [symbol] \tilde{x}ᵢ. In other words, the server 11 can recover [symbol] zᵢ by any U encoded masks, providing robustness against D dropped devices 235.

Theorem 1. Consider a secure aggregation problem in federated learning with N devices, the proposed LightSecAgg protocol can simultaneously achieve (1) privacy guarantee against up to any T colluding devices, and (2) dropout-resiliency guarantee against up to any D dropped devices, for any pair of privacy guarantee T and dropout-resiliency guarantee D such that T+D<N.

The proof of Theorem 1 is presented in Section B.

Remark 1. Theorem 1 provides a trade-off between privacy and dropout-resiliency guarantees, i.e., LightSecAgg can increase the privacy guarantee by reducing the dropout-resiliency guarantee and vice versa. LightSecAgg achieves the worst-case dropout-resiliency guarantee. That is, for any privacy guarantee T and the number of dropped devices D<N−T, LightSecAgg ensures that any set of dropped devices of size D) in secure aggregation can be tolerated. Differently, SecAgg+, FastSecAgg and TurboAgg relax the worst-case constraint to random dropouts, and provide probabilistic dropout-resiliency guarantee, i.e., the desired aggregate-model can be correctly recovered with high probability. Therefore, LightSecAgg is an improvement over other secure aggregation techniques such as SecAgg, SecAgg+, FastSecAgg and TurboAgg.

The storage cost, communication load, and computation load of the present techniques can be measured in unit of elements or operations in [symbol] _{q}. Recall that U is a design parameter chosen such that N−D≥U>T. The offline storage cost of the present techniques is as follows. Each device i independently generates a random mask zᵢ oflength d. Also, each device i stores a coded mask [zⱼ]ᵢ of size

$$\frac{d}{U - T}$$

for each j=1, . . . , N. Hence, the total offline storage cost at each device is

$$( 1 + \frac{N}{U - T} ) d .$$

The offline communication and computation loads of the present techniques can be as follows. For each iteration of secure aggregation, before the local model is computed, each device prepares offline coded random masks and distributes them to the other devices. Specifically, each device encodes U local data segments with each of size

$$\frac{d}{U - T}$$

into N coded segments and distributes each of them to one of N devices. Hence, the offline computation and communication load of LightSecAgg at each device is

$$O ( \frac{dN log N}{U - T} )$$

$$and$$

$$O ( \frac{dN}{U - T} )$$

respectively.

The communication load of the present techniques during aggregation of the present techniques is as follows. While each device uploads a masked model of length d, in the phase of aggregate-model recovery, no matter how many devices drop, each surviving device in U₁ sends The server 11 is guaranteed to recover the aggregate-model of the U1 a coded mask of size

$$\frac{d}{U - T} .$$

The server 11 is guaranteed to recover the aggregate-model of the U₁ after receiving messages from any U devices. The total required communication load at the server 11 in the phase of mask recovery is therefore

$$\frac{U}{U - T} d .$$

The computation load of the present techniques during aggregation. For LightSecAgg, the major computation bottleneck is the decoding process to recover [symbol] zⱼ at the server 11. This involves decoding a dimension-U MDS code from U coded symbols, which can be performed with O(U log U) operations on elements in [symbol] _{q}, hence a total computation load of

$$\frac{U log U}{U - T} d .$$

TABLE 1
Complexity comparison between SecAgg,
SecAgg+, and LightSecAgg. Here N is
the total number of devices, d is the model size,
s is the length of the secret keys
as the seeds for PRG (s << d).

| | SecAgg | SecAgg+ | LightSecAgg |
|---|---|---|---|
| Offline | O(sN) | O(s log N) | O(d) |
| communication | | | |
| per device | | | |
| Offline computation | O(dN + sN²) | O(d log N + | O(d log N) |
| per device | | s log²N) | |
| Online | O(d + sN) | O(d + | O(d) |
| communication | | s log N) | |
| per device | | | |
| Online | O(dN + sN²) | O(dN + | O(dN) |
| communication | | sN log N) | |
| at server | | | |
| Online computation | O(d) | O(d) | O(d) |
| per device | | | |
| Reconstruction | O(dN²) | O(dN log N) | O(d log N) |
| complexity at server | | | |

The communication and computation complexities of LightSecAgg can be compared with baseline protocols. In particular, the case where secure aggregation protocols aim at providing privacy guarantee

$$T = \frac{N}{2}$$

and dropout-resiliency guarantee D=pN simultaneously is considered, for some

$$0 \leq p < \frac{1}{2} .$$

As shown in Table 1, by choosing U=(1−p)N, LightSecAgg significantly improves the computation efficiency at the server during aggregation. SecAgg and SecAgg+ incurs a total computation load of O(dN²) and O(dN log N) respectively at the server, while the server complexity of LightSecAgg almost stays constant with respect to N. The is expected to substantially reduce the overall aggregation time for a large number of devices, which has been bottlenecked by the server's computation in SecAgg. More detailed discussions, as well as a comparison with another

TABLE 2
Summary of four implemented machine learning tasks and
performance gain of LightSecAgg with respect to SecAgg
and SecAgg+. All learning tasks can be for image classification.
FEMNIST and CIFAR- 100 can be low-resolution datasets,
while images in GLD-23K can be high resolution, which cost
much longer training time for one mini-batch; LR and CNN can
be shallow models, but MobileNetV3 and EfficientNet-
BO can be much larger models, but they can
be tailored for efficient edge training and inference.

| | | | Model | Gain Non- | Over- |
|---|---|---|---|---|---|
| No. | Dataset | Model | Size (d) | overlapped | lapped |
| 1 | FEMNIST | Logistic | 7,850 | 6.7×, 2.5× | 8.0×, 2.9× |
| | | Regression | | | |
| 2 | FEMNIST | CNN | 1,206,590 | 11.3×, 3.7× | 12.7×, 4.1× |
| 3 | CIFAR-100 | MobileNetV3 | 3,111,462 | 7.6×, 2.8× | 9.5×, 3.3× |
| 4 | GLD-23K | EfficientNet- | 5,288,548 | 3.3×, 1.6× | 3.4×, 1.7× |
| | | B0 | | | |

recently proposed secure aggregation protocol, which achieves similar server complexity as LightSecAgg, can be carried out in Section B.

The performance of the present techniques over two baseline protocols, SecAgg and SecAgg+ in a realistic FL framework with up to N=200 devices to train various machine learning models, is as follows.

In an example, the present techniques can be implemented on a distributed platform to train various machine learning models for image classification tasks, and examine its total running time of one global iteration with respect to the two baseline protocols. To model a FL framework, m3.medium instances over Amazon EC2 cloud can be used, and implement communication using the MPI4Py message passing interface on Python. To provide a comprehensive coverage of realistic FL settings, four machine learning models can be trained over datasets of different sizes, which is summarized in Table 2. The hyper-parameter settings can be provided in Section B.

The dropout and privacy modeling of an example can be as follows. To model the dropped devices, pN devices can be randomly selected, where p is the dropout rate. This can be considered the worst-case scenario in which the selected pN devices artificially drop after uploading the masked model. All three protocols provide privacy guarantee

$$T = \frac{N}{2}$$

and resiliency for three different dropout rates, p=0.1, p=0.3, and p=0.5.

The system-level optimization of an example is as follows. Three protocols can be implemented, LightSecAgg, SecAgg, and SecAgg+, and the following system-level optimizations can be applied to speed up their executions. The parallelization of offline phase and model training for an example is as follows. In all three protocols, communication and computation time to generate and exchange the random masks in the offline phase can be overlapped with model training. That is, each device locally trains the model and carries out the offline phase simultaneously by running two parallel threads.

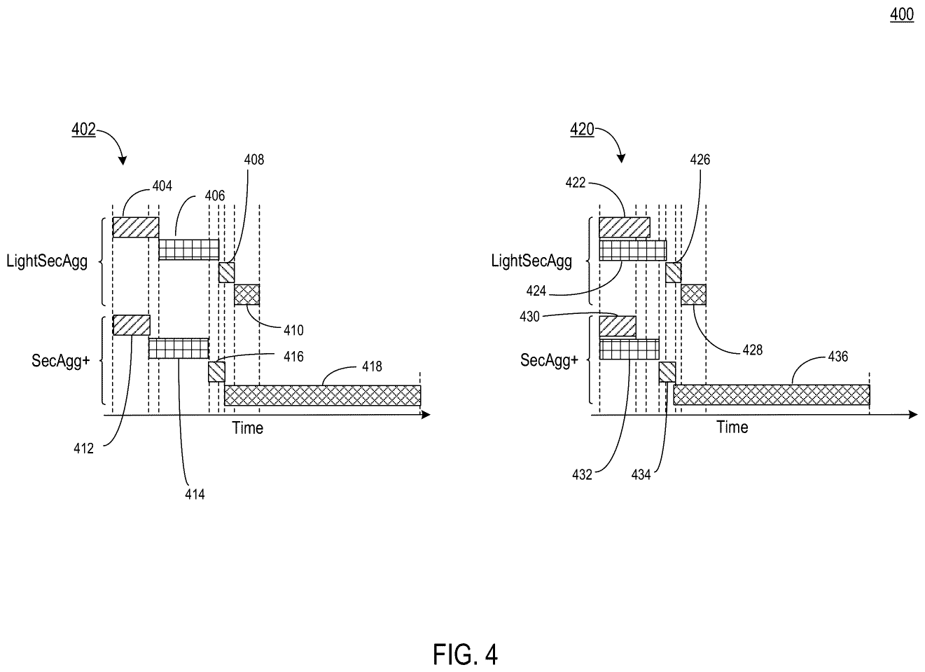

FIG. 4 depicts an example timing diagram of two different implementations, referred to non-overlapped implementation 402 and overlapped implementation 420. While detailed analysis will be provided later, total running time is reduced in the overlapped 420 case. As shown in FIG. 4, in the non-overlapped implementation 402, for each of the LightSecAgg and SecAgg+ protocols, offline time, shown by bars 404 and 412, training time, shown by bars 406 and 414, masking and uploading time, shown by bars 408 and 416, and aggregate-model recovery time, shown by bars 410 and 418, occur successively (i.e., there is no overlap). In the overlapped implementation 420, for each of the LightSecAgg and SecAgg+ protocols, offline time, shown by bars 422 and 430, training time, shown by bars 424 and 432, masking and uploading time, shown by bars 426 and 434, and aggregate-model recovery time, shown by bars 428 and 436, may occur, simultaneously for at least a period of time. For example, offline time 422 may occur at the same time as a portion of the training time 424, thus decreasing total runtime.

The amortized communication for an example is as follows. LightSecAgg can further speed up the communication time in the offline phase by parallelizing the transmission and reception of [\tilde{z}ᵢ]ⱼ via multi-threading.

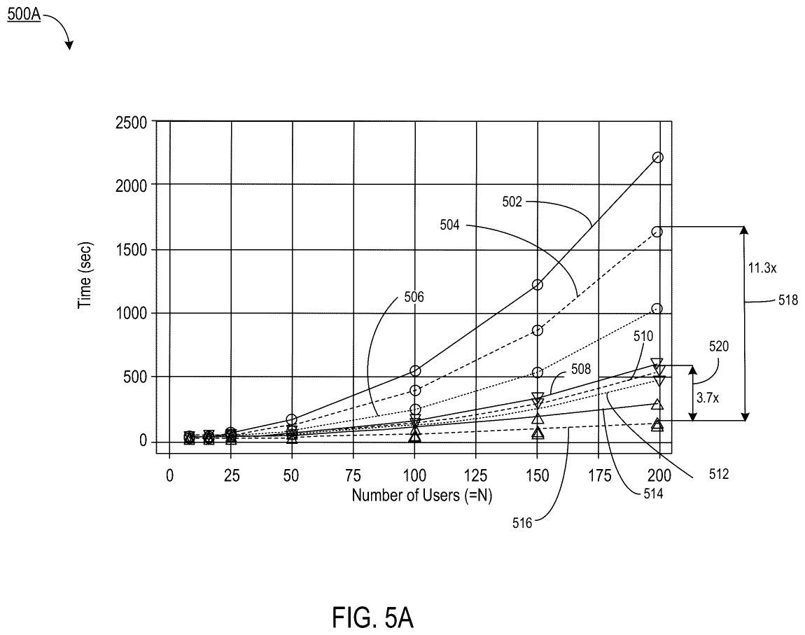

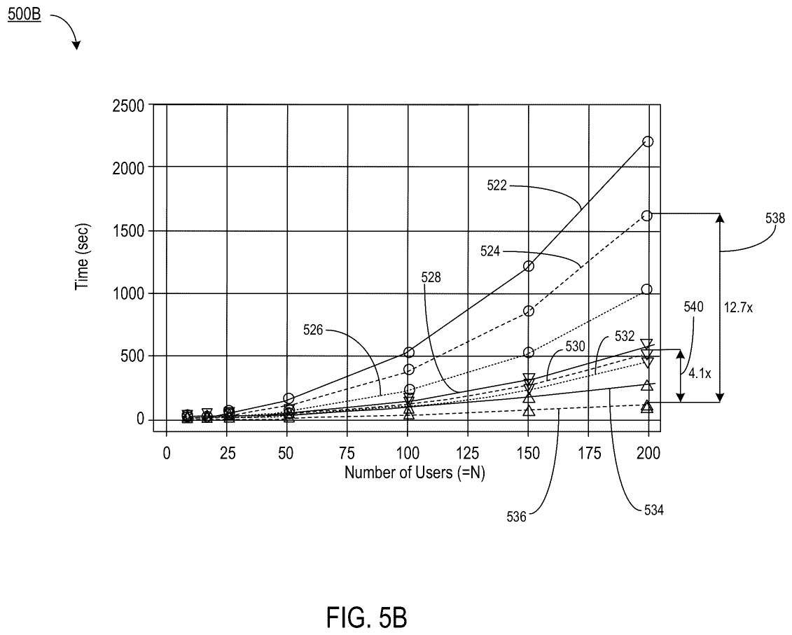

Example performance evaluation of an example is as follows. For the performance analysis, the total running time for a single round of a global iteration is measured, which includes model training and secure aggregation with each protocol while increasing the number of devices N gradually for different device dropouts. Example results to train CNN on the FEMNIST dataset are depicted in FIGS. 5A and 5B. Performance gain of LightSecAgg with respect to SecAgg and SecAgg+ to train the other models is also provided in Table 2. More detailed experimental results can be provided in Section B. For example, performance can be demonstrated by way of example in non-overlapped implementation 500A and overlapped implementation 500B.

The total running time of SecAgg and SecAgg+ increases monotonically with the dropout rate. This is because their total running time is dominated by the mask recovery at the server, which increases quadratically with the number of devices. As shown in FIG. 5A, lines 502, 504, 506, 508, 510, 512, 514, and 516 indicate the runs times in a non-overlapped implementation. Lines 502, 504, and 506 indicate a SecAgg protocol runtime with a 50% dropout rate, a 30% dropout rate, and a 10% dropout rate, respectively. Lines 508, 510, and 512 indicate SecAgg+ protocol runtimes with dropout rates of 50%, 30%, and 10%, respectively. Line 514 indicates a LightSecAgg protocol runtime with a 50% dropout rate. Line 516 indicates LightSecAgg protocol runtimes with both a 30% and 10% dropout rate, as the difference in runtimes are not distinguishable given the scale of the chart in 500A. In the non-overlapped implementation, LightSecAgg provides a speedup up to 11.3× and 3.7× over SecAgg and SecAgg+, respectively, by significantly reducing the server's execution time. Line 518 indicates the speedup between the SecAgg protocol runtime with a 30% dropout rate (i.e., line 504) and the LightSecAgg protocol runtime with a 30% dropout rate (i.e., line 516). Line 520 indicates the speedup between the SecAgg+ protocol runtime with a 30% dropout rate (i.e., line 510) and the LightSecAgg protocol runtime with a 30% dropout rate (i.e., line 516).

As shown in FIG. 5B, lines 522, 524, 526, 528, 530, 532, 534, and 536 indicate the runs times in an overlapped implementation. Lines 522, 524, and 526 indicate a SecAgg protocol runtime with a 50% dropout rate, a 30% dropout rate, and a 10% dropout rate, respectively. Lines 528, 530, and 532 indicate SecAgg+ protocol runtimes with dropout rates of 50%, 30%, and 10%, respectively. Line 534 indicates a LightSecAgg protocol runtime with a 50% dropout rate. Line 536 indicates LightSecAgg protocol runtimes with both a 30% and 10% dropout rate, as the difference in runtimes are not distinguishable given the scale of the chart in 500B. In the overlapped implementation, LightSecAgg provides a further speedup of up to 12.7× and 4.1× over SecAgg and SecAgg+, respectively. Line 538 indicates the speedup between the SecAgg protocol runtime with a 30% dropout rate (i.e., line 524) and the LightSecAgg protocol runtime with a 30% dropout rate (i.e., line 536). Line 540 indicates the speedup between the SecAgg+ protocol runtime with a 30% dropout rate (i.e., line 530) and the LightSecAgg protocol runtime with a 30% dropout rate (i.e., line 536).

The speedup is due to the fact that LightSecAgg requires more communication and computation cost in the offline phase than the baseline protocols and the overlapped implementation helps to mitigate this extra cost. LightSecAgg provides the smallest speedup in the most training-intensive task, training EfficientNet-B0 on GLD-23K dataset. This is due to the fact that training time is dominant in this task, and training takes almost the same time in LightSecAgg and baseline protocols. In particular, LightSecAgg provides significant speedup of the aggregate-model recovery phase at the server over the baseline protocols in all considered tasks.

In an example, the present techniques incur the smallest running time for the case of p=0.3, which is almost identical to the case of p=0.1. Recall that LightSecAgg can select design parameter U between T=0.5N and N−D=(1−p)N. Within this range, while increasing U reduces the size of the symbol to be decoded, it also increases the complexity of decoding each symbol. The example experimental results suggest that one choice for the cases of p=0.1 and p=0.3 can be both=[0.7N], which leads to a faster execution than the case of p=0.5 where U can only be chosen as U=0.5N+1.

The systems and methods described herein provide an improved approach for secure aggregation in federated learning. Compared with other secure aggregation protocols, the present techniques reduce the overhead of model aggregation in FL by leveraging one-shot aggregate-mask reconstruction of the active devices, while providing the same privacy and dropout-resiliency guarantees. In a realistic FL framework, extensive empirical results show that the present techniques can provide substantial speedup over baseline protocols for training diverse machine learning models with a performance gain, for example, of 12.7×, which is a significant improvement over other secure aggregation protocols.

The systems and methods described herein provide societal benefit of protecting device privacy in FL, where hundreds of devices can jointly train a global machine learning model without revealing information about their individual datasets. In addition, the systems and methods described herein can be combined byzantine resilient aggregation protocols in FL to address potential active/byzantine adversaries via model/data poisoning attacks.

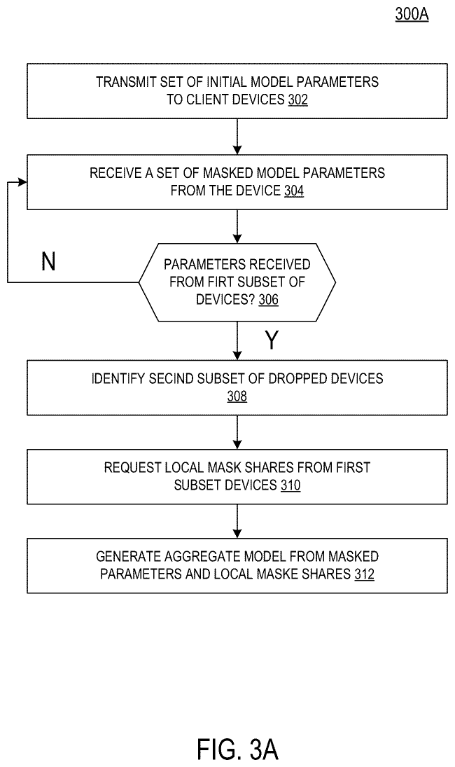

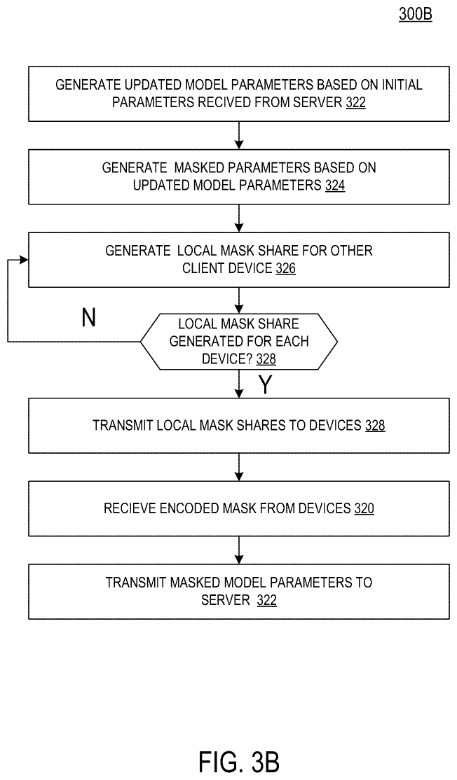

Referring now to FIG. 3A, depicted is an example flow diagram 300A of a method for improved secure aggregation in federated learning, in accordance with one or more implementations. The method 300A can be executed, performed, or otherwise carried out by the server 11 described herein in connection with FIGS. 1 and 2A-2G, the computer system 900 described in connection with FIGS. 9A and 9B, or any other computing devices described herein. In brief overview of the method 300A, at step 302, the server (e.g., the server 11, etc.) can transmit a set of initial model parameters to a plurality of client devices (e.g., one or more devices 150, such as the device 1, 2, i, . . . , N described herein in connection with FIGS. 1 and 2A-2G, etc.). At step 304, a set of masked model parameters are received from a device. At step 306, it is determined whether parameters have been received from a first subset of devices. If the parameters have not been received, the process returns to step 304. If the parameters have been received, the process continues to step 308. At step 308, a second subset of dropped devices is identified. At step 310, local mask shares are requested from the first subset of devices. At step 312, generate an aggregate model is generated from the masked model parameters and the aggregate of local mask shares.

In further detail of the method 300A, at step 302, the server (e.g., the server 11, etc.) can transmit a set of initial model parameters to client devices (e.g., one or more of the devices 150, such as the device 1, 2, i, . . . , N described herein in connection with FIGS. 1 and 2A-2G, etc.).In centralized federated learning, a central server coordinates distributed training of a model by performing aggregation of many model parameters trained by other client devices. Federated learning is generally performed through iterative “rounds,” during which an initial set of model parameters (or the set of aggregate model parameters generated in the previous round) can be transmitted to each of the client devices participating in the federated learning technique. The model parameters can be any parameters of any type of machine learning model, including arrays of weight values, bias values, lay information, model structure or process information (e.g., loss functions, training protocol, etc.), or any other types of information relating to the machine learning model being trained via federated learning. The server (e.g., server 11) can then allow each of the client devices 150 to train the initial set of model parameters using their own set of local training data to generate a locally trained model. These locally trained models can be then masked by each client device 150 (e.g., using the operations described herein in method 300B of FIG. 3B) and transmitted to the server for aggregation. Once the model is aggregated, the server 11 can initiate another round of federated learning by transmitting the aggregated model parameters to each of the client devices 150. These rounds can continue until a training condition is reached (e.g., if predetermined number of rounds have been completed, if a predetermined model accuracy has been reached, if a predetermined number of client devices “drop out” of the federated learning technique, etc.).

In some implementations, at the start of a round of federated learning, the server can determine which client devices 150 can be participating in the round of federated learning. To do so, the server 11 can attempt to initiate one or more communications sessions with each client device in a list of candidate client devices that can be eligible to participate in the federated learning protocol. In some implementations, the list of candidate client devices can be received from an external computing device, from a local configuration file, or generated by the server based on messages received from candidate client devices. To identify which client devices in the list will participate in a round, the server 11 can, for example, attempt to establish a communication session with each client device in the list, and transmit the set of initial model parameters for the round of federated learning to the client device via the communication session.

At step 304, the server can receive a set of masked model parameters from a device. As described herein, each of the client devices 150 can perform a training procedure using the initial model parameters and local training data to generate a local model. However, simply transmitting the locally trained models to the server exposes the models to potential model inversion attacks and impacts the privacy of the local training data at each client device 150. To protect the privacy of the local models at each client device 150, the server and the client devices 150 can participate in the secure aggregation protocol techniques described herein. In doing so, after each client device 150 trains their local model, the client device 150 masks the local model and transmits the masked model to the server. The server 11 can receive the local model, for example, in response to a request transmitted by the server 11 to the client device 150. Masking local model parameters can include adding information (e.g., the mask zᵢ) to the model to preserve the privacy of the model. In masking the updated model parameters, a client device “masks,” or obfuscates, the model parameters such that the unmasked updated model parameters cannot be obtained without subtracting the mask from the model. Using the processes described herein, the server can generate a one-shot reconstruction of the model using local mask shares generated by dropped and active client devices.

In some implementations, one or more client devices 150 participating in the techniques described herein may “drop out,” or become unresponsive to communications. In such implementations, the server 11 can attempt to communicate with a client device for a predetermined amount of time before determining whether the cease communications with the client device 150, and store a flag in association with an identifier of said client device 150 indicating that the client device 150 has dropped from the secure aggregation techniques described herein. In some implementations, a client device 150 can be identified as a “dropped” client device in response to other conditions (e.g., a detected signal quality between the server and the client device being below a predetermined threshold, etc.). If the server 11 can establish a valid communication session with a client device 150, the server 11 can transmit a request for the masked updated model parameters to the client device 150, and the receive the masked model parameters from the client device 150 in response to the request. In some implementations, client devices themselves can attempt to establish a communication with the server 11 upon completing generation of the updated masked model parameters, and transmit the updated masked model parameters to the server without the need for a corresponding request. The server 11 can store an indication that a client device 150 is active if the server 11 receives valid masked model parameters from the client device 150, and likewise store an indication that a client device 150 is dropped if the server 11 does not receive valid masked model parameters.

At step 306, the server 11 can determine whether parameters have been received from a first subset of devices. As described herein, the server 11 can operate the secure aggregation techniques using a predetermined parameter U, which indicates a required number of client devices that can be not dropped from the federated learning round in order for secure aggregation to be successful. The parameter U can be specified, for example, prior to starting the round of federated learning, and can likewise be shared with each of the client devices in step 302, with the initial model parameters for the round. To continue with secure aggregation, the server can determine whether updated and masked model parameters have been received from at least U client devices (e.g., a first subset of client devices). If updated and masked model parameters have not been received from at least U non-dropped client devices, the server can continue to execute step 304 of the method 300A and continue to request or wait for information to be received from client devices participating in the federated learning process. If updated and masked model parameters have been received from at least U client devices, the server can execute step 308 of the method 300A. In some implementations, the server may execute step 308 even when more than U client devices have provided updated and masked model parameters.

At step 308, the server 11 can identify a second subset of dropped. At this stage in the secure aggregation protocols described herein, the server 11 can determine which of the client devices 150 have dropped from the federated learning round. Using this information, the server 11 can request aggregated local mask share data from the remaining U client devices 150 to reconstruct the aggregate model in a one-shot reconstruction, as described herein. The server 11 can determine which of the client devices 150 can be dropped by accessing the list of client device identifiers identify client devices that have dropped from the federated learning protocol. Because the identifiers of client devices that failed to provide updated and masked model parameters can be stored in association with a flag, the server 11 can identify the dropped client devices (e.g., the second subset) by iterating through the list and identifying any “dropped” flags. The server 11 can then generate a list of dropped client devices as including identifiers of each client device 150 that is stored in association with a “dropped” flag. D represents the number of dropped devices.

At step 310, the server 11 can request the aggregate of local mask shares from the first subset of devices. Once the dropped client devices have been identified, the server 11 can request the aggregate of local mask shares corresponding to each of the active client devices from each of the active client devices in the first subset. In some implementations, the request can include an identification of each of the non-dropped client devices (e.g., client devices that provided the masked and updated model parameters). Upon receiving the request, each of the client devices 150 can determine the aggregate of mask shares for the active clients identified in the request, and transmit the aggregate of the local mask shares to the server 11 for secure one-shot aggregation of the machine learning model. The server 11 can store each of the received sets of local mask shares in one or more data structures in the memory of the server.

At step 312, the server can generate an aggregate model from the masked model parameters and local mask shares. Once the updated and mask model parameters and each set of local mask shares have been received from the first subset of the client devices 150, the server 11 can generate a one-shot reconstruction of the model. To do so, the server 11 can aggregate the local mask shares received from the active client devices [symbol] ₁ to calculate [symbol] zᵢ by concatenating [symbol] [zᵢ]ₖ's. As described herein, the sum of each set of local mask shares [symbol] [\tilde{z}ᵢ]ⱼ is an encoded version of [symbol] [zᵢ]ₖ for k∈[U−T] using the MDS matrix W. The proof for this theorem is described in Section B of the present disclosure. Once the aggregate mask is calculated by concatenating the sum of the local mask shares, the server 11 can perform one-shot model reconstruction to calculate the aggregate model [symbol] ₁xᵢ by subtracting the aggregate mask [symbol] zᵢ from the sum of the aggregate masked model parameters [symbol] \tilde{x}ᵢ. In doing so, the server 11 is able to recover an aggregate model using any U encoded masks, which provides robustness against D dropped devices and T colluding devices.

Referring now to FIG. 3B, depicted is an example flow diagram 300B of a method for generating secure masks for a secure aggregation protocol, in accordance with one or more implementations. The method 300B can be executed, performed, or otherwise carried out by one or more of the devices 150 (e.g., device 1, device 2, . . . , device N) described herein in connection with FIGS. 1 and 2A-2G, the computer system 900 described in connection with FIGS. 9A and 9B, or any other computing devices described herein. In brief overview of the method 300B, at step 322, a client device 150 (e.g., any of the devices 1, 2, i, . . . , N described herein in connection with FIGS. 1 and 2A-2G, etc.) can generate updated model parameters based on initial parameters received from a server. At step 324, a client device 150 can generate masked parameters based on updated model parameters. At step 326, the client device 150 can generate local mask shares for another client device. At step 328, the client device 150 can determine whether local mask shares have been generated for each other client device. At step 330, the client device 150 can transmit the local mask shares to the other client devices. At step 332, the client device 150 can receive encoded masks from the other client devices. At step 334, the client device 150 can and transmit the masked model parameters to the server 11.

In further detail of the method 300B, at step 322, the client device 150 (e.g., any of the devices 1, 2, i, . . . , N described herein in connection with FIGS. 1 and 2A-2G, etc.) can generate updated model parameters based on initial parameters received from a server 11. As described herein, client devices 150 participating in a round of federated learning can receive a set of initial model parameters from a server 11 in communication with the client devices 150. The server 11 can transmit the set of initial model parameters, for example, in response to a request from each of the client devices 150. The model parameters (described herein as model parameters xᵢ for each device i) can belong to any type of machine learning model, including a neural network (e.g., a fully connected network, a convolutional neural network, a recurrent neural network, or any combination thereof, etc.), a logistic regression model or other type of regression model, or any other type of machine learning model. Each client device 150 can maintain or receive local training data, which can be specific to the client device. Using an appropriate training process (e.g., logistic regression, backpropagation, other federate learning techniques, etc.), the client device 150 can compute updated model parameters using the training data. In general, training of the machine learning models can be performed in parallel across all of the client devices 150 in communication with the server 11. As described herein (e.g., in connection with FIGS. 2A-2G, method 300A of FIG. 3A, etc.), the server 11 can generate an aggregate model that represents the aggregate machine learning model across all participating client devices. Each client device 150 can use the machine learning process to iteratively update the initial model parameters received from the server for a round of federated learning until a training condition (e.g., predetermined amount of training data has been used, predetermined amount of time has passed, etc.) has been met. Once the updated machine learning parameters have been generated, the client device can proceed to execute step 324.

At step 324, the client device 150 can generate masked parameters based on updated model parameters. To make sure the models can be resistant to model inversion attacks that attempt to reconstruct training data from trained model parameters, the client device i can generate a mask zᵢ for its share of the model xᵢ. By summing the mask z and the set of model parameters x, the client device can effectively mask the true model parameters trained by the client device to protect against model inversion attacks. To generate the mask z, the client device selects a random set of values z (e.g., each corresponding to a respective parameter in the set of model parameters xᵢ) from the F-space [symbol] _{q}^{d} of the model xᵢ, where the local model xᵢ∈ [symbol] _{q}^{d}. In some implementations, randomly selecting values can include executing a random number generator that returns random values from [symbol] _{q}^{d}. In some implementations, the random number generator can be a pseudo-random number generator that utilizes a suitable pseudo-random number generation process. To generate an updated and masked set of model parameters \tilde{x}ᵢ, the client device can calculate a sum between the set of model parameters xᵢ and the generated mask zᵢ, such that \tilde{x}ᵢ=xᵢ+zᵢ, where i corresponds to the respective client device performing the method 300B in the secure aggregation protocol. In some implementations, the generation of the mask and the generation and sharing of local mask shares (e.g., steps 324-330) can be executed prior to generating the updated model parameters xᵢ from the initial model parameters received from the server 11.

At step 326, the client device 150 can generate local mask shares for another client device. Once the local mask zᵢ is generated by the client device, the local mask is partitioned to U−T sub-masks

$${[ {z}_{i} ]}_{k} ∈ {𝔽}_{q}^{\frac{d}{U - T}} ,$$

k∈[U−T] of equal size, where U is a predetermined number of client devices that must survive (e.g., be able to communicate information with the server at the aggregation phase of the federated learning round), and T is the predetermined number of devices that can collude without risking privacy of any piece of the aggregate model xᵢ. To protect against T colluding devices, the client device 150 can randomly select a value [nᵢ]ₖ's from the F-space

$${𝔽}_{q}^{\frac{d}{U - T}} ,$$

for k∈{U−T+1, . . . , U} device i∈[N] encodes sub-masks [zᵢ]ₖ's as [\tilde{z}ᵢ]ⱼ=([zᵢ]_{1, . . . ,} [zᵢ]_{U-T}, [nᵢ]_{U-T+1, . . . ,} [nᵢ]_{U})·Wⱼ, where N is the number of client devices participating in the federated learning round. The value N can be provided by the server to the client device, for example, when the server transmits the initial model parameters to the client device. In the formula above, the data structure Wⱼ is j-th column of a T-private MDS matrix W∈ [symbol] _{q}^{U×N} of dimension U×N. An MDS matrix is considered T-private if the submatrix consists of its {U−T+1, . . . , U}−th rows is also MDS. A T-private MDS matrix guarantees I (\tilde{z}ᵢ; {[\tilde{z}ᵢ]ⱼ [symbol] =0, for any i∈[N] and any [symbol] ∈[N] of size T, if [nᵢ]ₖ's can be jointly uniformly random. The values of [nᵢ]ₖ can be selected or generated by the client device to be jointly uniformly random. The T-private MDS matrices can be calculated for any U, N, and T.

At step 328, the client device 150 can determine whether local mask shares have been generated for each other client device. The client device can calculate each value [\tilde{z}ᵢ]ⱼ for j∈[N], and therefore generate an encoded mask partition for each [\tilde{z}ᵢ]_{N}, where i represents the client device executing the method 300B. The client device can iteratively perform these calculations, for example, sequentially or in parallel. The client device can determine whether the set of local mask shares has been generated by incrementing the counter register j each time the value of [\tilde{z}ᵢ]ⱼ is generated. If the counter register j is equal to the number of participating client devices N, the client device can execute STEP 330 of the method 300B to share the local mask shares with the other client devices participating in the federated learning round. If the counter register j is not equal to the number of participating client devices N, the client device can increment the counter register j and execute step 326.

At step 330, the client device can transmit the local mask shares to the other client devices. After computing the mask shares [\tilde{z}ᵢ]ⱼ for each client device N, the client device i can transmit [\tilde{z}ᵢ]ⱼ to each device j∈[N]\{i}. In the end of offline encoding and sharing of local masks, the client device i, and each client device i∈[N], has local mask shares [\tilde{z}ⱼ]ᵢ from each client device j∈[N]. Transmitting the mask shares to each client device can include, for example, initiating a communication session between each of the client devices. Once each client device j has received mask shares [\tilde{z}ᵢ]ⱼ generated by the client device i, each client device j can transmit a confirmation message to the client device i indicating that mask shares [\tilde{z}ᵢ]ⱼ have been received.

at step 332, the client device can receive encoded masks from the other client devices. Likewise, the client device i can receive the local mask shares [\tilde{z}ⱼ] generated by each of the client devices j. As such, in the end of offline encoding and sharing of local masks, the client device i, and each client device i∈[N], has local mask shares [\tilde{z}ⱼ]ᵢ from each client device j∈[N]. Upon the client device i receiving all of the local mask shares [\tilde{z}ⱼ]ᵢ from a client device j, the client device i can transmit a confirmation message to the client device j indicating that all of the local mask shares generated by the client device j have been received. As described herein above, in some implementations, mask share generation and sharing can occur prior to generating the updated model parameters in step 322.

At step 334, the client device can transmit the masked model parameters to the server. Once the masked model parameters can be generated by the client device, and local mask shares have been transmitted to the other client devices participating in the federated learning round, the client device i can transmit the updated and masked model parameters \tilde{x}ᵢ to the client device. As described herein above, the server 11 can utilize the updated and masked model parameters from each client device to perform a secure one-shot aggregation of the updated model as described at least in the method 300A shown in FIG. 3A. After the server 11 receives updated and masked model parameters from each of the surviving (e.g., not dropped) client devices, the server 11 can identify and transmit requests for local mask shares from each of the surviving client devices.

The client device 150 can receive the request from the server 11. The request can identify a subset of the participating client devices that can be not dropped from the federated learning round. Client devices 150 can be dropped from a federated learning round for by satisfying a drop condition. For example, the server may be unable to establish a communication session between the server and a client device, and subsequently determine that the client device should be dropped. In some implementations, the drop condition can be a connection quality metric between the server and a client device that falls below a predetermined connectivity threshold.

In response to the request, the client device 150 can transmit the aggregate of local mask shares that correspond to surviving client devices identified in the request to the server 11. In some implementations, the client device 150 can aggregate the subset of the local mask shares prior to transmission, for example, by computing a sum of the local mask shares as [symbol] [\tilde{z}ᵢ]ⱼ, where [symbol] ₁ represents the subset of surviving client devices, and i represents the client device performing the method 300B. Using the aggregated subset of the local mask shares, the server can perform one-shot reconstruction of the aggregate model of all surviving client devices as described herein in connection with the method 300B of FIG. 3B. Upon completion of a round of federated learning, the client device 150 may receive a request from the server to initiate a second round of federated learning that includes a set of model parameters and identifiers of other client devices participating in the federated learning round. The client device 150 can then initiate step 322 of the method 300B in response to such request, to carry out the round of federated learning using the secure aggregation techniques described herein.

### B. Pseudo-Code, Data, and Theorems

Pseudo Code of LightSecAgg

Process 1 The LightSecAgg protocol
Input: T (privacy guarantee), D (dropout-resiliency guarantee), U (target number of
surviving devices)

| | |
|---|---|
| 1: | Server Executes: |
| 2: | // phase: offline encoding and sharing of local masks |
| 3: | for each device i = 1, 2, . . . , N in parallel do |
| 4: | zᵢ ← randomly picks from [symbol] _{q}^{t} |
| 5: | [zᵢ]₁, . . ., [zᵢ]_{U-T} ← obtained by partitioning zᵢ to U − T pieces |
| 6: | ${[ {n}_{i} ]}_{U - t + 1} , … , {[ {n}_{i} ]}_{U} ← randomly picks from {𝔽}_{q}^{\frac{d}{U - T}}$ |
| 7: | {[\tilde{z}ᵢ]ⱼ}_{j∈[N]} ← obtained by encoding [zᵢ]ₖ's and [nᵢ]ₖ's using (10) |
| 8: | sends encoded mask [\tilde{z}ᵢ]ⱼ to device j ∈ [N]\{i} |
| 9: | receives encoded mask [\tilde{z}ⱼ]ᵢ to device j ∈ [N]\{i} |
| 10: | end for |
| 11: | // phase: masking and uploading of local models |
| 12: | for each device i = 1, 2, . . ., N in parallel do |
| 13: | // device i obtains xᵢ after the local update |
| 14: | \tilde{x}ᵢ − xᵢ + zᵢ // masks the local model |
| 15: | uploads masked model \tilde{x}ᵢ to the server |
| 16: | end for |
| 17: | identifies set of surviving devices [symbol] ₁ ⊆ [N] |
| 18: | gathers masked models \tilde{x}ᵢ from device i ∈ [symbol] ₁ |
| 19: | // phase: one-shot aggregate-model recovery |
| 20: | for each device i ∈ [symbol] ₁ 1 in parallel do |
| 21: | computes aggregated encoded masks [symbol] [\tilde{z}ⱼ]ᵢ, |
| 22: | uploads aggregated encoded masks [symbol] [\tilde{z}ⱼ]ᵢ to the server |
| 23: | end for |
| 24: | collects U messages of aggregated encoded masks [symbol] [\tilde{z}ⱼ]ᵢ from device i ∈ [symbol] ₁ |
| 25: | // recovers the aggregated-mask |
| 26: | [symbol] zᵢ ← obtained by decoding the received U messages |
| 27: | // recovers the aggregate-model for the surviving devices |
| 28: | [symbol] xᵢ ← [symbol] \tilde{x}ᵢ − [symbol] zᵢ |

### Proof of Theorem 1

For any pair of privacy guarantee T and dropout-resiliency guarantee D such that T+D<N, an arbitrary U is selected such that N−D≥U>T. In the following, it is shown that LightSecAgg with chosen design parameters T, D and U can simultaneously achieve (1) privacy guarantee against up to any T colluding devices, and (2) dropout-resiliency guarantee against up to any D dropped devices. The concatenation of {[nᵢ]ₖ}_{k∈U-T+1, . . . , U} is denoted by nᵢ for i∈[N]. Since each device encodes its sub-masks by the same MDS matrix W, each [symbol] [\tilde{z}ᵢ]ⱼ is an encoded version of [symbol] [\tilde{z}ᵢ]ₖ for k∈[U−T] and [symbol] [nᵢ]ₖ for k∈{U−T+1, . . . , U} as follows:

$${[ {\tilde{z}}_{i} ]}_{j} = ( {[ {z}_{i} ]}_{1} , … , {[ {z}_{i} ]}_{U - T} , [ {z}_{i} {[}_{U - T + 1} , … , {[ {n}_{i} ]}_{U} ) {W}_{j} \qquad ( 11 )$$

where Wⱼ is the j-th column of W. Since N−D≥U, there can be at least U surviving devices after device dropouts. Thus, the server is able to recover [symbol] [zᵢ]ₖ for k∈[U−T] via MDS decoding after receiving a set of any U messages from the surviving devices. Recall that [zᵢ]ₖ's can be sub-masks of zᵢ, so the server can successfully recover [symbol] zᵢ. Lastly, the server recovers the aggregate-model for the set of surviving devices by [symbol] ₁ by [symbol] xᵢ= [symbol] \tilde{x}ᵢ− [symbol] zᵢ= [symbol] (xᵢ+zᵢ)− [symbol] zᵢ

Lemma 1 is presented below, whose proof is provided in Section B.

Lemma 1. For any [symbol] ⊆[N] of size T and any [symbol] ₁⊆[N], | [symbol] ₁|≥U such that U≥T, if the random masks [nᵢ]ₖ's can be jointly uniformly random:

$$I ( \{ {z}_{i} ; \{ {z}_{i} , \{ {[ {\tilde{z}}_{j} ]}_{i} ) = 0 \qquad ( 12 )$$

The worst-case can be that all the messages sent from the devices can be received by the server during the execution of LightSecAgg, e.g., the devices identified as dropped can be delayed. Thus, the server receives xᵢ+zᵢ from device i∈[N] and [symbol] [\tilde{z}ⱼ]ᵢ from device i∈ [symbol] ₁. It is now shown that LightSecAgg provides privacy guarantee T, i.e., for an arbitrary set of colluding devices [symbol] of size T, the following holds,

$$I ( {\{ {x}_{i} \}}_{i ∈ [ N ]} ; {\{ {x}_{i} + {z}_{i} \}}_{i ∈ [ N ]} , \{ {[ {\tilde{z}}_{j} ]}_{i} \vert {x}_{i} \{ {x}_{i} , \} {\{ {z}_{i} \}}_{i ∈ τ} , \{ {[ {\tilde{z}}_{j} ]}_{i} ) = 0 \qquad ( 13 )$$

The proof is as follows:

$$I {( {\{ {x}_{i} \}}_{i ∈ [ N ]} ; \{ {x}_{i} + {z}_{i} )}_{i ∈ [ N ]} , {\{ {[ {\tilde{z}}_{j} ]}_{i} \}}_{i ∈ 𝒰} \vert {\sum }_{i ∈ {𝒰}_{i}} {x}_{i} \{ {x}_{i} , {\{ {z}_{i} \}}_{i ∈ 𝒥} , {\{ {[ {\tilde{z}}_{j} ]}_{i} \}}_{j ∈ [ N ] , i ∈ 𝒥} ) \qquad ( 14 )$$

$$= H ( {\{ {x}_{i} + {z}_{i} \}}_{i ∈ [ N ]} , {\{ {[ {\tilde{z}}_{j} ]}_{i} \}}_{i ∈ {𝒰}_{1}} \vert {\sum }_{i ∈ 𝒰} {x}_{i} , {\{ {x}_{i} \}}_{i ∈ 𝒥} , {\{ {z}_{i} \}}_{i ∈ 𝒥} , \{ {[ {\tilde{z}}_{j} ]}_{i} ) - H ( {\{ {x}_{i} + {z}_{i} \}}_{i ∈ [ N ]} , \{ {{\sum }_{j ∈ {𝒰}_{i}} [ {\tilde{z}}_{j} ]}_{i ∈ 𝒰} \vert {\{ {x}_{i} \}}_{i ∈ 𝒥} {\{ {z}_{i} \}}_{i ∈ [ N ]} , \{ {[ {\tilde{z}}_{j} ]}_{j ∈ [ N ] , i ∈ 𝒥} ) \qquad ( 15 )$$

$$= H ( {\{ {x}_{i} + {z}_{i} \}}_{i ∈ [ N ]} , {\sum }_{i ∈ {𝒰}_{1}} {z}_{i} , {\sum }_{i ∈ {𝒰}_{1}} {n}_{i} \vert {\sum }_{i ∈ {𝒰}_{i}} {x}_{i} , {\{ {x}_{i} \}}_{i ∈ 𝒥} , {\{ {z}_{i} \}}_{i ∈ 𝒥} , {\{ {[ {\tilde{z}}_{j} ]}_{i} \}}_{j ∈ [ N ] , i ∈ 𝒥} ) - H ( {\{ {z}_{i} \}}_{i ∈ [ N ]} , {\sum }_{i ∈ {𝒰}_{1}} {z}_{i} {\sum }_{i ∈ {𝒰}_{1}} {n}_{i} \vert {\{ {x}_{i} \}}_{i ∈ 𝒥} , {\{ {z}_{i} \}}_{i ∈ [ N ]} , {\{ {[ {\tilde{z}}_{j} ]}_{i} \}}_{j ∈ [ N ] , i ∈ 𝒥} ) \qquad ( 16 )$$

$${= H ( \{ {x}_{i} + {z}_{i} , {z}_{i} , {n}_{i} \vert {x}_{i} , \{ {x}_{i} , {\{ {z}_{i} \}}_{i ∈ 𝒥} , \{ {\tilde{z}}_{j} ]}_{i} ) - H ( {\{ {z}_{i} \}}_{i ∈ [ N ]} , {z}_{i} , {n}_{i} \vert {\{ {x}_{i} \}}_{i ∈ [ N ]} , {\{ {z}_{i} \}}_{i ∈ 𝒥} , {\{ {[ {z}_{j} ]}_{i} \}}_{j ∈ [ N \} , i ∈ 𝒥} ) \qquad ( 17 )$$

$$= H ( {\{ {x}_{i} + {z}_{i} \}}_{i ∈ [ N ] \backslash 𝒥} \vert {\sum }_{i ∈ {𝒰}_{1}} {x}_{i} , {\{ {x}_{i} \}}_{i ∈ 𝒥} , {\{ {z}_{i} \}}_{i ∈ 𝒥} , {\{ {[ {\tilde{z}}_{j} ]}_{i} \}}_{j ∈ [ N ] , i ∈ 𝒥} ) + H ( {\sum }_{i ∈ {𝒰}_{1}} {z}_{i} , {\sum }_{i ∈ {𝒰}_{1}} {n}_{i} \vert {\{ {x}_{i} + {z}_{i} \}}_{i ∈ [ N ] \backslash 𝒥} , {\sum }_{i ∈ {𝒰}_{1}} {x}_{i} , {\{ {x}_{i} \}}_{i ∈ 𝒥} , {\{ {z}_{i} \}}_{i ∈ 𝒥} , {\{ {[ {\tilde{z}}_{j} ]}_{i} \}}_{j ∈ [ N ] , i ∈ 𝒥} ) - H ( {\{ {z}_{i} \}}_{i ∈ [ N ]} \vert {\{ {x}_{i} \}}_{i ∈ [ N [} , {\{ {z}_{i} \}}_{i ∈ 𝒥} , {\{ {[ {\tilde{z}}_{j} ]}_{i} \}}_{j ∈ [ N ] , i ∈ 𝒥} ) - H ( {\sum }_{i ∈ {𝒰}_{1}} {z}_{i} , {\sum }_{i ∈ {𝒰}_{i}} {n}_{i} \vert {\{ {z}_{i} \}}_{i ∈ [ N ]} , {\{ {x}_{i} \}}_{i ∈ [ N ]} , {\{ {[ {\tilde{z}}_{j} ]}_{i} \}}_{j ∈ [ N ] , i ∈ 𝒥} ) \qquad ( 18 )$$

$$= H {( \{ {x}_{i} + {z}_{i} )}_{i ∈ [ N ] \backslash 𝒥} \vert {\sum }_{i ∈ {𝒰}_{1}} {x}_{i} , {\{ {x}_{i} \}}_{i ∈ 𝒥} , {\{ {z}_{i} \}}_{i ∈ 𝒥} , {\{ {[ {\tilde{z}}_{j} ]}_{i} \}}_{j ∈ [ N ] , i ∈ 𝒥} ) + H ( {\sum }_{i ∈ {𝒰}_{1}} {n}_{i} \vert {\{ {x}_{i} + {z}_{i} \}}_{i ∈ [ N ] \backslash 𝒥} , {\sum }_{i ∈ {𝒰}_{1}} {x}_{i} {\{ {x}_{i} \}}_{i ∈ 𝒥} , \{ {[ {z}_{i} ]}_{i ∈ 𝒥} , {\{ {[ {z}_{i} ]}_{j} \}}_{j ∈ [ N ] , i ∈ 𝒥} ) - H ( {\{ {z}_{i} \}}_{i ∈ [ N ] \backslash 𝒥} , \vert {\{ {z}_{i} \}}_{i ∈ 𝒥} , {\{ {[ {\tilde{z}}_{j} ]}_{i} \}}_{j ∈ [ N ] , i ∈ 𝒥} ) - H ( {\sum }_{i ∈ {𝒰}_{1}} {n}_{i} \vert {\{ {z}_{i} \}}_{i ∈ [ N ]} , {\{ {[ {\tilde{z}}_{j} ]}_{i} \}}_{j ∈ [ N ] , i ∈ 𝒥} ) \qquad ( 19 )$$

$$= H ( {\{ {x}_{i} + {z}_{i} \}}_{i ∈ [ N [ \backslash 𝒥} \vert {\sum }_{i ∈ {𝒰}_{1}} {x}_{i} , {\{ {x}_{i} \}}_{i ∈ 𝒥} {\{ {z}_{i} \}}_{i ∈ 𝒥} , {{\{ {[ {z}_{j} ]}_{i} \}}_{j ∈ [ N ] ,}}_{i ∈ 𝒥} ) + H ( {\sum }_{i ∈ {𝒰}_{i}} {n}_{i} \vert {\{ {x}_{i} + {z}_{i} \}}_{i ∈ [ N ] \backslash 𝒥} , {\sum }_{i ∈ {𝒰}_{1}} {x}_{i} , {\{ {x}_{i} \}}_{i ∈ 𝒥} , {\{ {z}_{i} \}}_{j ∈ 𝒥} , {\{ {[ {\tilde{z}}_{j} ]}_{i} \}}_{j ∈ [ N ] , i ∈ 𝒯} ) - H ( \{ {z}_{i} ) - H ( {n}_{i} \vert \{ {z}_{i} , \{ {[ {\tilde{z}}_{j} ]}_{i} ) \qquad ( 20 )$$

$$= 0 \qquad ( 21 )$$

where (16) follows from the fact that { [symbol] is invertible to [symbol] zᵢ and [symbol] , nᵢ Equation (17) holds since {xᵢ+zᵢ [symbol] , is a deterministic function of {zᵢ [symbol] and {xᵢ [symbol] . Equation (18) follows from the chain rule. In equation (19), the second term follows from the fact that is a deterministic function of {xᵢ+zᵢ [symbol] , [symbol] xᵢ, {xᵢ [symbol] , {zᵢ [symbol] ; the third term follows from the independence of xᵢ's and zᵢ's; the last term follows from the fact that [symbol] zᵢ is a deterministic function of {zᵢ}_{i∈[N]} and the independence of nᵢ's and xᵢ's. In equation (20), the third term follows from Lemma 1. Equation (21) follows from 1) [symbol] nᵢ a function of {xᵢ+zᵢ [symbol] , [symbol] xᵢ, {xᵢ [symbol] {zᵢ [symbol] and {[\tilde{z}ⱼ]ᵢ [symbol] ; 2) [symbol] nᵢ is a function of {zᵢ [symbol] , {[\tilde{z}ⱼ]ᵢ [symbol] , 3) zᵢ is uniformly distributed and hence it has the maximum entropy in [symbol] _{q}^{d}, combined with the non-negativity of mutual information.

As shown in Table 3, compared with the SecAgg protocol, LightSecAgg significantly improves the computation efficiency at the server during aggregation. While SecAgg requires the server to retrieve T+1 secret shares of a secret key for each of the N devices, and to compute a single PRG function if the device survives, or N−1 PGR functions to recover N−1 pairwise masks if the device drops off, yielding a total computation load of O(N²d) at the server. In contrast, for U=O(N), LightSecAgg incurs an almost constant O(dlogN)) computation load at the server. This admits a scalable design and is expected to achieve a much faster end-to-end execution for a large number of devices, given the fact that the overall execution time is dominated by the server's computation in SecAgg. SecAgg has a smaller storage overhead than LightSecAgg as secret shares of keys with small size (e.g., as small as an integer) can be stored, and the model size d is much larger than the number of devices N in typical FL scenarios. This effect will also allow SecAgg to have a smaller communication load in the phase of aggregate-model recovery. Finally, it is noted that another advantage of LightSecAgg over SecAgg is the reduced dependence on cryptographic primitives like public key infrastructure and key agreement mechanism, which further simplifies the implementation of the protocol. SecAgg+ improves both communication and computation load of SecAgg by considering a sparse random graph of degree O(logN), and the complexity is reduced by factor of

$$O ( \frac{N}{log N} ) .$$

However, SecAgg+ still incurs O(dN log N) computation load at the server, which is much larger than O(d log N) computation load at the server in LightSecAgg when U=O(N).

TABLE 3
Complexity comparison between SecAgg, SecAgg+, and
LightSecAgg. Here, N is the total number of devices. The parameters d
and s respectively represent the model size and the length of the secret
keys as the seeds for PRG, where s << d. LightSecAgg and SecAgg
provide worst-case privacy guarantee T and dropout-resiliency guarantee
D for any T and D as long as T + D < N. SecAgg+ provides probabilistic
privacy guarantee T and dropout-resiliency guarantee D. LightSecAgg
selects three design parameters T, D and U such that T < U ≤ N − D.

| | SecAgg | SecAgg+ | LightSecAgg |
|---|---|---|---|
| Offline storage per device | O(d + Ns) | O(d + s log N) | $O ( d + \frac{N}{U - T} d )$ |
| Offline communication per device | O(sN) | O(s log N) | $O ( d \frac{N}{U - T} )$ |
| Offline computation per device | O(dN + sN²) | O (d log N + s log² N) | $O ( d \frac{N log N}{U - T} )$ |
| Online communication per device | O(d + sN) | O(d + slo g N) | $O ( d + \frac{d}{U - T} )$ |
| Online communication at server | O(dN + sN²) | O(dN + sN log N) | $O ( dN + d \frac{U}{U - T} )$ |
| Online computation per device | O(d) | O(d) | $O ( d + d \frac{U}{U - T} )$ |
| Decoding complexity at server | O(sN²) | O(sN log² N) | $O ( d \frac{U log U}{U - T} )$ |
| PRG complexity | O(dN²) | O(dN log N) | — |
| at server | | | |

TABLE 4
Comparison of storage cost (in the number of
$symbols in {𝔽}_{q}^{\frac{d}{U - T}} ) between protocol in and LightSecAgg .$

| | Protocol in | LightSecAgg |
|---|---|---|
| Total amount of randomness needed | $N ( U - T ) + T {\sum }_{u = U}^{N} ( \begin{matrix}N \\ u\end{matrix} )$ | NU |
| Offline storage per device | $U - T + {\sum }_{u = U}^{N} ( \begin{matrix}N \\ u\end{matrix} ) \frac{u}{N}$ | U − T + N |

In other techniques, all randomness can be generated at some external trusted party, and for each subset of [symbol] ₁ of size | [symbol] ₁|≥U the trusted party needs to generate T random symbols in

$${𝔽}_{q}^{\frac{d}{U - T}} ,$$

which account to a total amount of randomness that increases exponentially with N. LightSecAgg does not require a trusted third party, and each device generates locally a set of T random symbols. It significantly improve the practicality of LightSecAgg to maintain model security, and further reduce the total amount of needed randomness to scale linearly with N. Consequently, the local offline storage of each device in LightSecAgg scales linearly with N, as opposed to scaling exponentially.

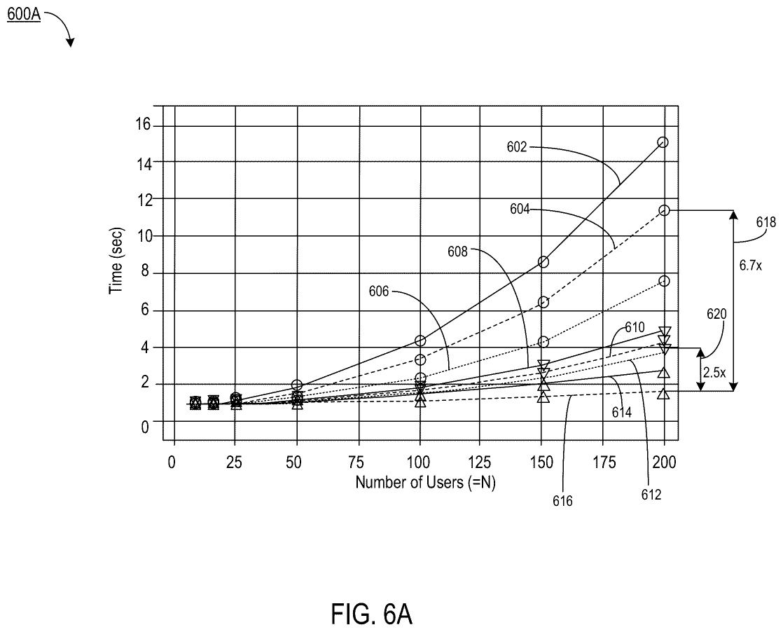

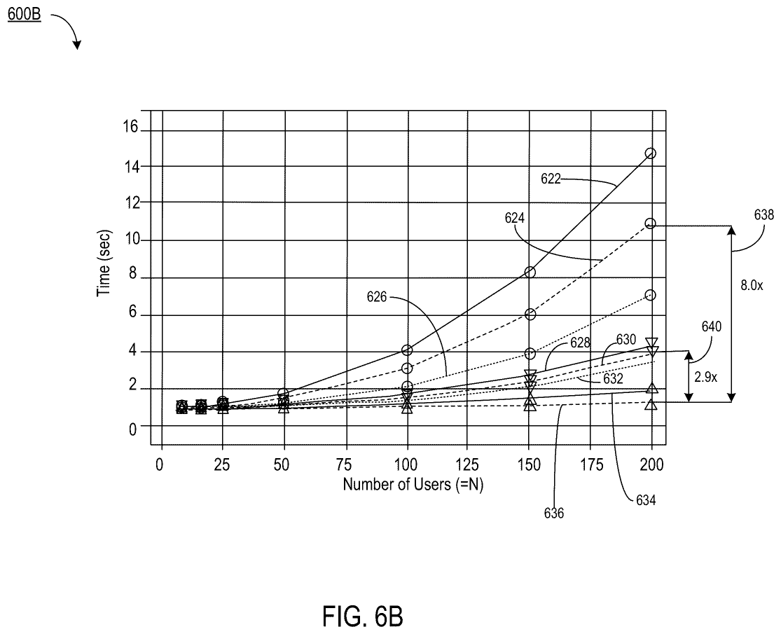

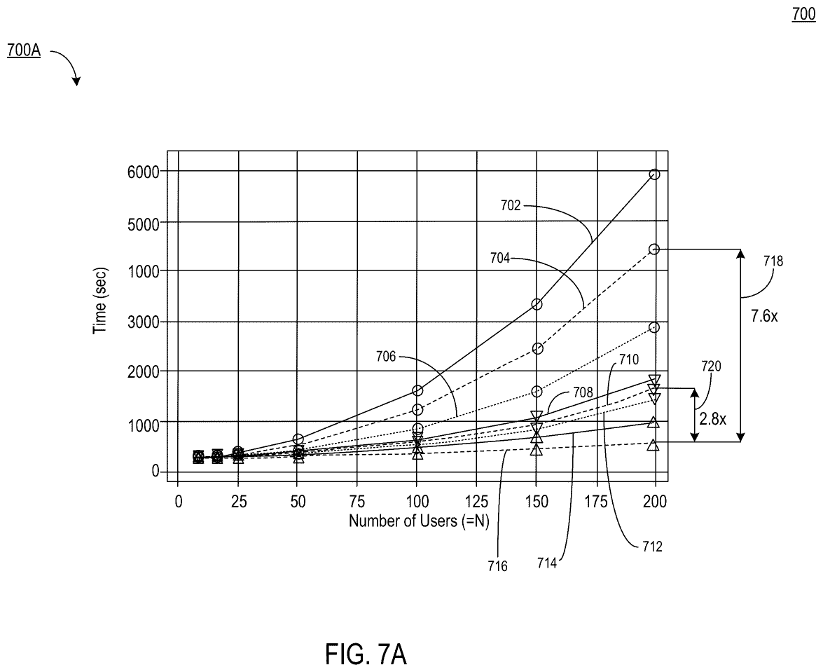

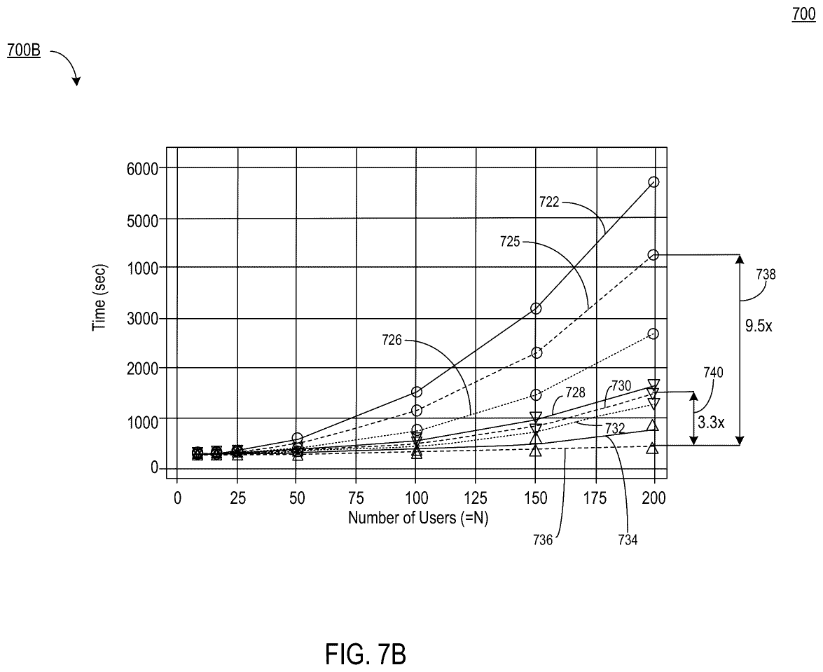

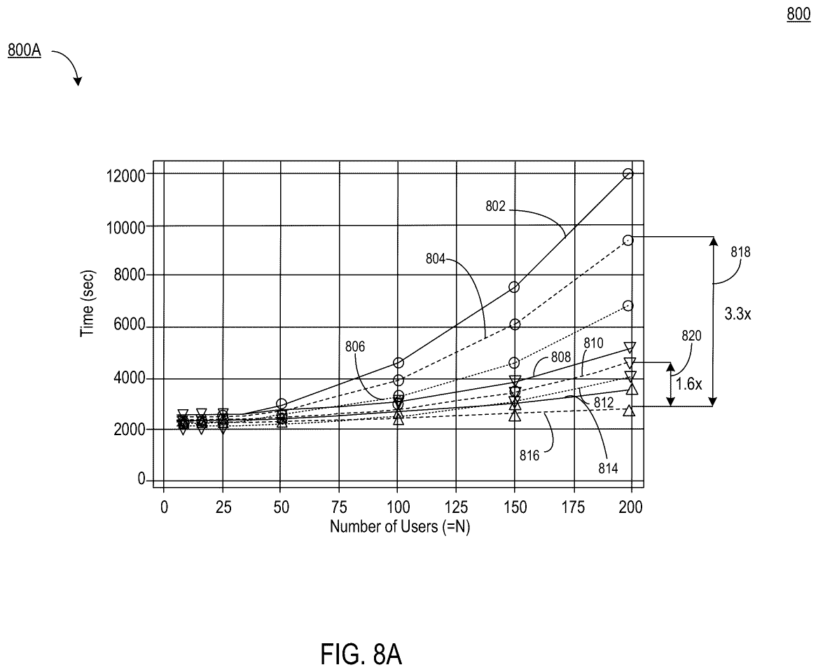

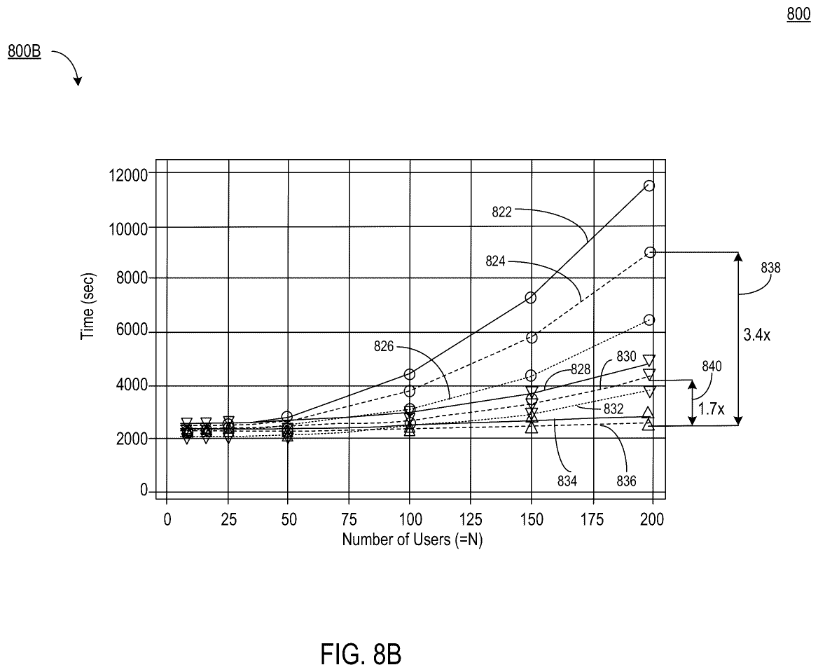

In this section, example experiment details are provided. Besides the results on training CNN on the FEMNIST dataset as shown in FIGS. 5A and 5B, the total running time of LightSecAgg is demonstrated versus two protocols, SecAgg and SecAgg+, to train logistic regression on the FEMNIST dataset, MobileNetV3 on the CIFAR-100 dataset, and EfficientNet-B0 on the GLD23k dataset in FIGS. 6A, 6B, 7A, 7B, 8A, and 8B, respectively. Lines 602-620 of FIG. 6A, lines 702-720 of FIG. 7B, and lines 802-820 of FIG. 8A may represent data similar to each of lines 502-520 described in FIG. 5A, respectively. Further, lines 622-640 of FIG. 6B, lines 722-740 of FIG. 7B, and lines 822-840 of FIG. 8B may represent data similar to each of lines 522-540 described in FIG. 5B, respectively. For all considered FL training tasks, each device locally trains its model with Ε=5 local epochs, before masking and uploading of its model. It is observed that LightSecAgg provides significant speedup for all considered FL training tasks in the running time over SecAgg and SecAgg+. To further investigate the primary gain of LightSecAgg, the breakdown of total running time for training CNN on the FEMNIST dataset can be provided in Table 5. Breakdown of the running time confirms that the primary gain lies in the complexity reduction at the server provided by LightSecAgg, especially for large number of devices. For example, performance can be demonstrated by way of example in non-overlapped implementations 600A, 700A, or 800A, and overlapped implementations 600B, 700B or 800B.

TABLE 5
Breakdown of the running time (sec) of LightSecAgg and the state-of-
the-art protocols (SecAgg and SecAgg+) to train CNN on the FEMNIST
dataset with N = 200 devices, for dropout rate p = 10%, 30%, 50%.

| | | Non-overlapped | | | Overlapped | | |
|---|---|---|---|---|---|---|---|
| Protocols | Phase | p = 10% | p = 30% | p = 50% | p = 10% | p = 30% | p = 50% |
| LightSecAgg | Offline | 69.3 | 69.0 | 191.2 | 75.1 | 74.9 | 196.9 |
| | Training | 22.8 | 22.8 | 22.8 | | | |
| | Uploading | 12.4 | 12.2 | 21.6 | 12.6 | 12.0 | 21.4 |
| | Recovery | 40.9 | 40.7 | 64.5 | 40.7 | 41.0 | 64.9 |
| | Total | 145.4 | 144.7 | 300.1 | 123.4 | 127.3 | 283.2 |
| SecAgg | Offline | 95.6 | 98.6 | 102.6 | 101.2 | 102.3 | 101.3 |
| | Training | 22.8 | 22.8 | 22.8 | | | |
| | Uploading | 10.7 | 10.9 | 11.0 | 10.9 | 10.8 | 11.2 |
| | Recovery | 911.4 | 1499.2 | 2087.0 | 911.2 | 1501.3 | 2086.8 |
| | Total | 1047.5 | 1631.5 | 2216.4 | 1030.3 | 1614.4 | 2198.9 |
| SecAgg+ | Offline | 67.9 | 68.1 | 69.2 | 73.9 | 73.8 | 74.2 |
| | Training | 22.8 | 22.8 | 22.8 | | | |
| | Uploading | 10.7 | 10.8 | 10.7 | 10.7 | 10.8 | 10.9 |
| | Recovery | 379.1 | 436.7 | 495.5 | 378.9 | 436.7 | 497.3 |
| | Total | 470.5 | 538.4 | 608.2 | 463.6 | 521.3 | 582.4 |

### Proof of Lemma 1

For an arbitrary set of colluding devices [symbol] of size T:

$$I ( {\{ {z}_{i} \}}_{i ∈ [ N ] ∖ 𝒥} ; \vert {\{ {z}_{i} \}}_{i ∈ 𝒥} , {\{ {[ {\tilde{z}}_{j} ]}_{i} \}}_{j ∈ [ N ] , i ∈ 𝒥} ) = 0 \qquad ( 22 )$$

The T-private MDS matrix used in LightSecAgg guarantees I (zᵢ; {[\tilde{z}ᵢ]ⱼ [symbol] )=0. Thus,

$$I {( \{ {z}_{i} ; \{ [ {z}_{i} ] )}_{i ∈ 𝒥} , \{ {[ {\tilde{z}}_{j} ]}_{i} ) \qquad ( 23 )$$

$$= H ( {\{ {z}_{i} \}}_{i ∈ 𝒥} , {\{ {[ {\tilde{z}}_{j} ]}_{i} \}}_{j ∈ [ N ] , i ∈ 𝒥} ) - H ( \{ {z}_{i} , {\{ {[ {\tilde{z}}_{j} ]}_{i} \}}_{j ∈ [ N ] , i ∈ 𝒥} \vert {[ {z}_{i} ]}_{i ∈ [ N ] \backslash 𝒥} ) \qquad ( 24 )$$

$${{= H ( [ {z}_{i} \}}_{i ∈ 𝒥} , \{ {[ {\tilde{z}}_{j} ]}_{j ∈ [ N ] , i ∈ 𝒥} ) - H ( [ {z}_{i} \}}_{i ∈ 𝒥} , \vert {\{ {z}_{i} \}}_{i ∈ [ N ] \backslash 𝒥} ) - H ( {\{ {[ {\tilde{z}}_{j} ]}_{i} \}}_{j ∈ [ N ] , i ∈ 𝒥} \vert {\{ {z}_{i} \}}_{i ∈ [ N ]} ) \qquad ( 25 )$$

$${{= H ( {\{ {z}_{i} \}}_{i ∈ 𝒥} , {\{ {[ {\tilde{z}}_{j} ]}_{i} \}}_{j ∈ [ N ] , i ∈ 𝒥} ) - H ( {\{ {z}_{i} \}}_{i ∈ 𝒥} ) - H ( \{ {\tilde{z}}_{j} ]}_{i} \}}_{j ∈ [ N ] , i ∈ 𝒥} ) \qquad ( 26 )$$

$$= 0 , \qquad ( 27 )$$

where equation (25) follows from the chain rule. Equation (26) follows from the independence of zᵢ's and I (zᵢ; {[\tilde{z}ᵢ]ⱼ [symbol] )=0. Equation (27) follows from the fact that joint entropy is less than or equal to the sum of the individual entropies, combined with the non-negativity of mutual information

### C. Computing and Network Environment

Having discussed specific embodiments of the present solution, it may be helpful to describe aspects of the operating environment as well as associated system components (e.g., hardware elements) in connection with the methods and systems described herein. The details of an embodiment of each device (e.g., the devices participating in the federated learning technique, the server, etc) are described in greater detail with reference to FIGS. 9B and 9C. A network environment in which the devices or server operate can be an ad hoc network environment, an infrastructure wireless network environment, a subnet environment, etc. in one embodiment.

Network connections between the devices or servers described herein may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The device(s) or server(s) described herein may be deployed as and/or executed on any type and form of computing device, such as a computer, network device or appliance capable of communicating on any type and form of network and performing the operations described herein. FIGS. 9B and 9C depict block diagrams of a computing device 900 useful for practicing an embodiment of the device(s) or server(s) described herein. As shown in FIGS. 9A and 9B, each computing device 900 includes a central processing unit 921, and a main memory unit 922. As shown in FIG. 9A, a computing device 900 may include a storage device 928, an installation device 916, a network interface 918, an I/O controller 923, display devices 924a-924n, a keyboard 926 and a pointing device 927, such as a mouse. The storage device 928 may include, without limitation, an operating system and/or software 920. As shown in FIG. 9B, each computing device 900 may also include additional optional elements, such as a memory port 903, a bridge 970, one or more input/output devices 930a-930n (generally referred to using reference numeral 930), and a cache memory 940 in communication with the central processing unit 921.

The central processing unit 921 is any logic circuitry that responds to and processes instructions fetched from the main memory unit 922. In many embodiments, the central processing unit 921 is provided by a microprocessor unit, such as: those manufactured by Intel Corporation of Mountain View, California; those manufactured by International Business Machines of White Plains, New York; or those manufactured by Advanced Micro Devices of Sunnyvale, California. The computing device 900 may be based on any of these processors, or any other processor capable of operating as described herein.

Main memory unit 922 may be one or more memory chips capable of storing data and allowing any storage location to be directly accessed by the microprocessor 921, such as any type or variant of Static random access memory (SRAM), Dynamic random access memory (DRAM), Ferroelectric RAM (FRAM), NAND Flash, NOR Flash and Solid State Drives (SSD). The main memory 922 may be based on any of the above described memory chips, or any other available memory chips capable of operating as described herein. In the embodiment shown in FIG. 9A, the processor 921 communicates with main memory 922 via a system bus 950 (described in more detail below). FIG. 9B depicts an embodiment of a computing device 900 in which the processor communicates directly with main memory 922 via a memory port 903. For example, in FIG. 9B the main memory 922 may be DRDRAM.

FIG. 9B depicts an embodiment in which the main processor 921 communicates directly with cache memory 940 via a secondary bus, sometimes referred to as a backside bus. In other embodiments, the main processor 921 communicates with cache memory 940 using the system bus 950. Cache memory 940 typically has a faster response time than main memory 922 and is provided by, for example, SRAM, BSRAM, or EDRAM. In the embodiment shown in FIG. 9B, the processor 921 communicates with various I/O devices 930 via a local system bus 950. Various buses may be used to connect the central processing unit 921 to any of the I/O devices 930, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 924, the processor 921 may use an Advanced Graphics Port (AGP) to communicate with the display 924. FIG. 9B depicts an embodiment of a computer 900 in which the main processor 921 may communicate directly with I/O device 930b, for example via HYPERTRANSPORT, RAPIDIO, or INFINIBAND communications technology. FIG. 9B also depicts an embodiment in which local busses and direct communication can be mixed: the processor 921 communicates with I/O device 930a using a local interconnect bus while communicating with I/O device 930b directly.

A wide variety of I/O devices 930a-930n may be present in the computing device 900. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 923 as shown in FIG. 9A. The I/O controller may control one or more I/O devices such as a keyboard 926 and a pointing device 927, e.g., a mouse or optical pen. Furthermore, an I/O device may also provide storage and/or an installation medium 916 for the computing device 900. In still other embodiments, the computing device 900 may provide USB connections (not shown) to receive handheld USB storage devices such as the USB Flash Drive line of devices manufactured by Twintech Industry, Inc. of Los Alamitos, California.

Referring again to FIG. 9A, the computing device 900 may support any suitable installation device 916, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 900 may further include a storage device, such as one or more hard disk drives or redundant arrays of independent disks, for storing an operating system and other related software, and for storing application software programs such as any program or software 920 for implementing (e.g., configured and/or designed for) the systems and methods described herein. Optionally, any of the installation devices 916 could also be used as the storage device. Additionally, the operating system and the software can be run from a bootable medium.

Furthermore, the computing device 900 may include a network interface 918 to interface to the network 904 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 900 communicates with other computing devices 900′ via any type and/or form of gateway or tunneling protocol such as Secure Socket Layer (SSL) or Transport Layer Security (TLS). The network interface 918 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

In some embodiments, the computing device 900 may include or be connected to one or more display devices 924a-924n. As such, any of the I/O devices 930a-930n and/or the I/O controller 923 may include any type and/or form of suitable hardware, software, or combination of hardware and software to support, enable or provide for the connection and use of the display device(s) 924a-924n by the computing device 900. For example, the computing device 900 may include any type and/or form of video adapter, video card, driver, and/or library to interface, communicate, connect or otherwise use the display device(s) 924a-924n. In one embodiment, a video adapter may include multiple connectors to interface to the display device(s) 924a-924n. In other embodiments, the computing device 900 may include multiple video adapters, with each video adapter connected to the display device(s) 924a-924n. In some embodiments, any portion of the operating system of the computing device 900 may be configured for using multiple displays 924a-924n. One ordinarily skilled in the art will recognize and appreciate the various ways and embodiments that a computing device 900 may be configured to have one or more display devices 924a-924n.

In further embodiments, an I/O device 930 may be a bridge between the system bus 950 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 900 of the sort depicted in FIGS. 9A and 9B may operate under the control of an operating system, which control scheduling of tasks and access to system resources. The computing device 900 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc .; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others.

The computer system 900 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 900 has sufficient processor power and memory capacity to perform the operations described herein.

In some embodiments, the computing device 900 may have different processors, operating systems, and input devices consistent with the device. For example, in one embodiment, the computing device 900 is a smart phone, mobile device, tablet or personal digital assistant. In still other embodiments, the computing device 900 is an Android-based mobile device, an iPhone smart phone manufactured by Apple Computer of Cupertino, California, or a Blackberry or WebOS-based handheld device or smart phone, such as the devices manufactured by Research In Motion Limited. Moreover, the computing device 900 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

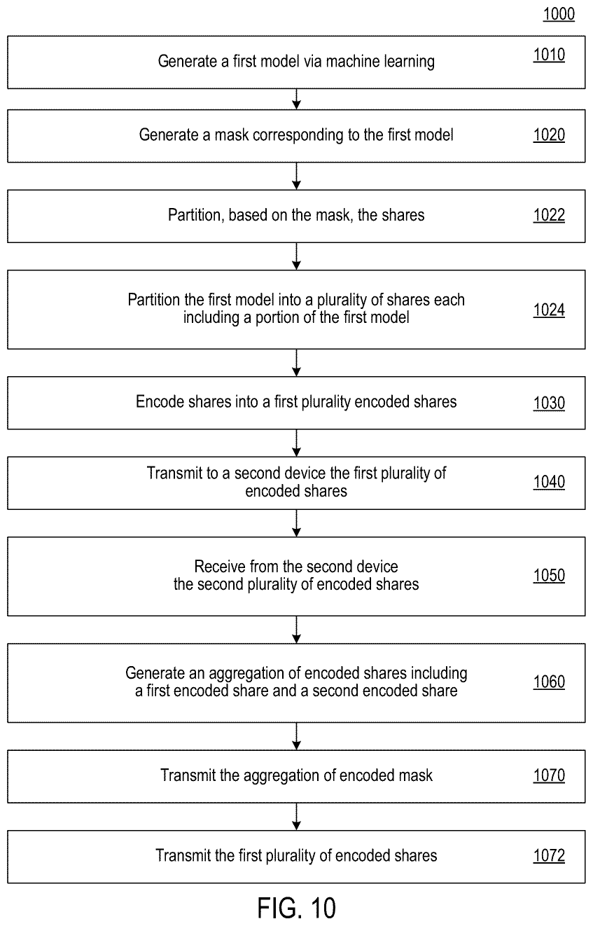

FIG. 10 illustrates a method to generate a model based on a subset of models generated at remote devices in accordance with present implementations. At least one of the example system flow diagrams 200A-D can perform method 1000 according to present implementations. The method 1000 can begin at 1010.

At 1010, the method 1000 can generate a first model via machine learning. For example, the method 1000 can generate a first model via machine learning based on a model parameter and data restricted to a first device operatively coupled with a second device. The method 1000 can then continue to 1020.

At 1020, the method 1000 can generate a mask corresponding to the first model. For example, the method 1000 can generate a plurality of random masks each corresponding to one or more of the distinct portions of the first model. For example, a random mask can be generated based on a random or pseudorandom number generation process. The method 1000 can then continue to 1022. At 1022, the method 1000 can partition, based on the mask, the shares. For example, the method 1000 can partition, based on the plurality of random masks, the plurality of local mask shares. The method 1000 can then continue to 1024. At 1024, the method 1000 can partition the first model into a plurality of shares each including a portion of the first model. For example, the method 1000 can partition the first model into a plurality of local mask shares each including a distinct portion of the first model. For example, a distinct portion can include a portion that contains content unique to the portion and not present in another portion. The method 1000 can then continue to 1030.

At 1030, the method 1000 can encode shares into a first plurality of encoded shares. For example, the method 1000 can encode one or more of the plurality of local mask shares into a corresponding first plurality of encoded shares. For example, each local mask share can be encoded into a particular and distinct encoded share. The method 1000 can then continue to 1040.

At 1040, the method 1000 can transmit to a second device the first plurality of encoded shares. For example, the method 1000 can transmit, to the second device and based on a device index of the second device, the first plurality of encoded shares. The method 1000 can then continue to 1050.

At 1050, the method 1000 can receive from the second device the second plurality of encoded shares. For example, the method 1000 can receive, from the second device and based on a device index of the first device, the second plurality of encoded shares. The method 1000 can then continue to 1060.

At 1060, the method 1000 can generate an aggregation of encoded shares including a first encoded share and a second encoded share. For example, the method 1000 can generate an aggregation of encoded shares including a first encoded share having a first index among the first plurality of encoded shares and a second encoded share having the first index among a second plurality of encoded shares, the second encoded share including a distinct portion of a second model generated by a second device via machine learning. The method 1000 can then continue to 1070.

At 1070, the method 1000 can transmit the aggregation of encoded masks. For example, the method 1000 can transmit, to a server operatively coupled with the first device, the aggregation of encoded masks. The method 1000 can then continue to 1072. At 1072, the method 1000 can transmit the first plurality of encoded shares. For example, the method 1000 can transmit, to the server, the first plurality of encoded shares.

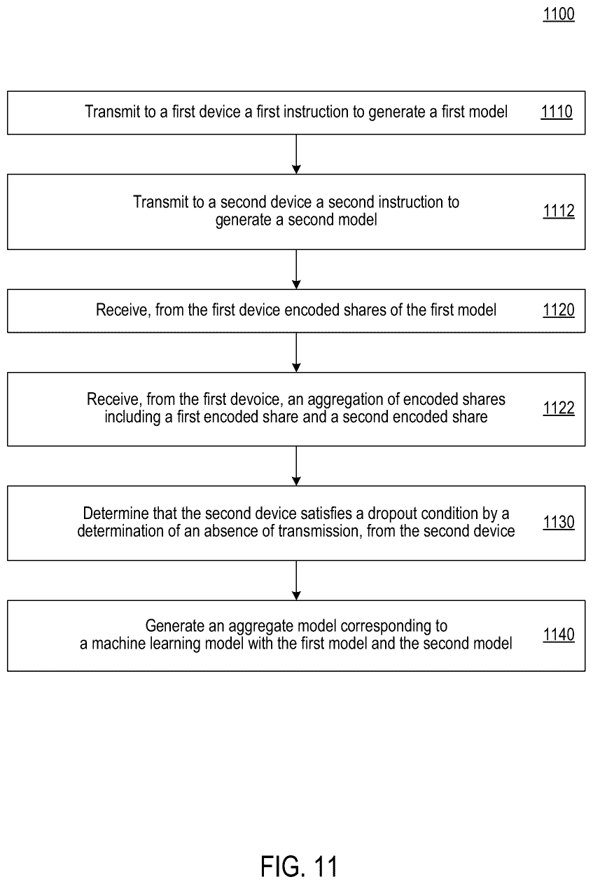

FIG. 11 illustrates a method to generate a model based on a subset of models generated at remote devices in accordance with present implementations. At least one of the example system flow diagrams 200E-G can perform method 1100 according to present implementations. The method 1100 can begin at 1110.

At 1110, the method 1100 can transmit to a first device a first instruction to generate a first model. For example, the method 1100 can transmit, to a first device, a first instruction to generate via machine learning a first model based on a model parameter and data restricted to the first device. A model parameter can include, for example, a constraint on execution of training of a model, a constraint on or identification of data input to or output by the model, or any combination thereof. The method 1100 can then continue to 1112. At 1112, the method 1100 can transmit to a second device a second instruction to generate a second model. For example, the method 1100 can transmit, to the second device, a second instruction to generate via machine learning a second model based on the model parameter and data restricted to the second device. The method 1100 can then continue to 1120.

At 1120, the method 1100 can receive, from the first device encoded shares of the first model. For example, the method 1100 can receive, from the first device, a plurality of encoded shares each including a distinct portion of the first model generated by the first device. The method 1100 can then continue to 1122. At 1122, the method 1100 can receive, from the first device, an aggregation of encoded shares including a first encoded share and a second encoded share. For example, the method 1100 can receive, from the first device, an aggregation of encoded shares including a first encoded share having a first index among the plurality of encoded shares and a second encoded share having the first index among the second plurality of encoded shares, the second encoded share including a distinct portion of the second model generated by the second device via machine learning. For example, an index can correspond to a relative position or an absolute position in a sequence, vector or the like. The method 1100 can then continue to 1130.

At 1130, the method 1100 can determine that the second device satisfies a dropout condition by a determination of an absence of transmission, from the second device. For example, the method 1100 can determine that the second device satisfies the dropout condition by a determination of an absence of transmission, from the second device, of the second plurality of encoded shares each including a distinct portion of the second model generated by the second device. A dropout condition can include, for example, a timeout condition indicating that at least a portion of a data object or model has not been received with a predetermined time period or by a predetermined timestamp or the like. The method 1100 can then continue to 1140.

At 1140, the method 1100 can generate an aggregate model corresponding to a machine learning model with the first model and the second model. For example, the method 1100 can generate, in response to a determination that the second device satisfies a dropout condition and based on the first plurality of encoded shares and the first aggregation of encoded shares, an aggregate model corresponding to a machine learning model comprising the first model and the second model.

Although the disclosure may reference one or more “users,” such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

1. A system to generate a model based on a subset of models generated at remote devices, the system comprising:
a first device operatively coupled with a second device, the first device including a processor and memory to:
generate, based on a model parameter and data restricted to the first device, a first model via machine learning;
partition the first model into a plurality of local mask shares each including a distinct portion of the first model;
encode one or more of the plurality of local mask shares into a corresponding first plurality of encoded shares; and
generate an aggregation of encoded shares including a first encoded share having a first index among the first plurality of encoded shares and a second encoded share having the first index among a second plurality of encoded shares, the second encoded share including a distinct portion of a second model generated by a second device via machine learning.

2. The system of claim 1, the first device to:
transmit, to the second device and based on a device index of the second device, the first plurality of encoded shares.

3. The system of claim 1, the first device to:
receive, from the second device and based on a device index of the first device, the second plurality of encoded shares.

4. The system of claim 1, the first device to:
generate a plurality of random masks each corresponding to one or more of the distinct portions of the first model; and
partition, based on the plurality of random masks, the plurality of local mask shares.

5. The system of claim 1, the first device remote from the second device.

6. The system of claim 1, the first device to:
transmit, to a server operatively coupled with the first device, the aggregation of encoded masks; and
transmit, to the server, the first plurality of encoded shares.

7. The system of claim 6, the first device to:
cause, in response to the transmission to the server, the server to generate, in response to a determination that the second device satisfies a dropout condition and based on the first plurality of encoded shares and the first aggregation of encoded shares, an aggregate model corresponding to a machine learning model comprising the first model and the second model.

8. The system of claim 7, the first device to:
cause, in response to the transmission to the server, the server to determine that the second device satisfies the dropout condition by a determination that an absence of transmission, from the second device, of second plurality of encoded shares each including a distinct portion of the second model generated by the second device.

9. The system of claim 1, the first device to:
receive, from a server operatively coupled with the first device, an instruction to generate via machine learning the first model based on the model parameter and the data restricted to the first device.

10. A method to generate a model based on a subset of models generated at remote devices, the method comprising:
generating, based on a model parameter and data restricted to a first device operatively coupled with a second device, a first model via machine learning;
partitioning the first model into a plurality of local mask shares each including a distinct portion of the first model;
encoding one or more of the plurality of local mask shares into a corresponding first plurality of encoded shares; and
generating an aggregation of encoded shares including a first encoded share having a first index among the first plurality of encoded shares and a second encoded share having the first index among a second plurality of encoded shares, the second encoded share including a distinct portion of a second model generated by a second device via machine learning.

11. The method of claim 10, comprising:
transmitting, to the second device and based on a device index of the second device, the first plurality of encoded shares.

12. The method of claim 10, comprising:
receiving, from the second device and based on a device index of the first device, the second plurality of encoded shares.

13. The method of claim 10, comprising:
generating a plurality of random masks each corresponding to one or more of the distinct portions of the first model; and
partitioning, based on the plurality of random masks, the plurality of local mask shares.

14. The method of claim 10, the first device remote from the second device.

15. The method of claim 10, comprising:
transmitting, to a server operatively coupled with the first device, the aggregation of encoded masks; and
transmitting, to the server, the first plurality of encoded shares.

16. The method of claim 15, comprising:
causing, in response to the transmission to the server, the server to generate, in response to a determination that the second device satisfies a dropout condition and based on the first plurality of encoded shares and the first aggregation of encoded shares, an aggregate model corresponding to a machine learning model comprising the first model and the second model.

17. The method of claim 16, comprising:
causing, in response to the transmission to the server, the server to determine that the second device satisfies the dropout condition by a determination that an absence of transmission, from the second device, of second plurality of encoded shares each including a distinct portion of the second model generated by the second device.

18. The method of claim 10, comprising:
receiving, from a server operatively coupled with the first device, an instruction to generate via machine learning the first model based on the model parameter and the data restricted to the first device.

19. A computer readable medium including one or more instructions stored thereon and executable by a processor to:
generate, by the processor and based on a model parameter and data restricted to the first device, a first model via machine learning;
partition, by the processor, the first model into a plurality of local mask shares each including a distinct portion of the first model;
encode, by the processor, one or more of the plurality of local mask shares into a corresponding first plurality of encoded shares; and
generate, by the processor, an aggregation of encoded shares including a first encoded share having a first index among the first plurality of encoded shares and a second encoded share having the first index among a second plurality of encoded shares, the second encoded share including a distinct portion of a second model generated by a second device via machine learning.

20. The computer readable medium of claim 19, wherein the computer readable medium further includes one or more instructions executable by the processor to:
transmit, to the second device and based on a device index of the second device, the first plurality of encoded shares.

21-41. (canceled)
